(19) United States
(12) Patent Application Publication
(10) Pub. No.: US 2007/0174506 A1
(43) Pub. Date: Jul. 26, 2007

(54) Data processing apparatus

(75) Inventor: Toru Tsuruta, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/397,804

(22) Filed: Apr. 5, 2006

(30) Foreign Application Priority Data
Dec. 29, 2005 (JP) 2005-380609

(51) Int. Cl. G06F 13/28

(52) U.S. Cl. 710/22

(57) ABSTRACT

A data processing apparatus in which DMA transfer is performed. When a processor in a data processing unit outputs a first request to read data managed by a data management unit, a receiver-side DMA controller outputs a second request for DMA transfer, from the data processing unit to the data management unit through a dedicated line. Next, a memory controller in the data management unit reads out from the memory the data designated by the second request, and stores the data in a buffer. Then, a transmitter-side DMA controller acquires a right of use of a bus, and the memory controller transfers the data stored in the buffer, through the bus by DMA, and writes the data in a data storage area in the data processing unit.

### CROSS-REFERENCE TO RELATED APPLICATIONS

This application is based upon and claims the benefits of priority from the prior Japanese Patent Application No. 2005-380609, filed on Dec. 29, 2005, in Japan, and the contents of which are incorporated herein by reference.

### BACKGROUND OF THE INVENTION

1. Field of the Invention

The present invention relates to a data processing apparatus which performs DMA (Direct Memory Access) transfer, and in particular, to a data processing apparatus which is required to perform real-time processing.

2. Description of the Related Art

Currently, the information processing technology is used in various fields. Among others, in some technical fields including image processing, processing of a great amount of data is required. In particular, in some particular applications, processing of a great amount of data is required to be performed in real time.

For example, in a known technique, images taken by a camera mounted on a car are analyzed by using a microcomputer in order to automatically control the car. When this technique is used, it is possible to automatically move the car to a parking lot, and control the car so as not to deviate from a lane. However, when the image processing is delayed, it becomes impossible to correctly control the car. Therefore, it is necessary to maintain the real-time performance while processing a great amount of data. In order to perform processing of a great amount of data, a processing system having high processing capability and memory-access capability is necessary.

In the systems in which a great amount of data is processed in real time, a plurality of process blocks are pipeline processed by a plurality of processing engine cores. The number of processing engine cores used for performing the pipeline processing is determined on the basis of the processing capabilities of the processing engine cores and the real-time performance required by each application.

In addition, in the image processing, in which real-time processing of a great amount of data is required, the bus performance is a great factor which affects the system performance. In particular, when the processing engine cores are realized by dedicated hardware, the hardware is required to have a structure which enables processing of a great amount of data in a short time. Therefore, when the data-transfer performance of a bus is low, the processing engine cores are required to wait for data, and cannot exhibit their full processing capabilities.

Usually, data transfer is realized by DMA (Direct Memory Access), and each system containing a CPU (Central Processing Unit) has a structure in which a DMA controller is connected to a CPU bus. The DMA controller temporarily acquires a right of use of the CPU bus (which is under control of the processor), and performs data transfer between two memories connected to the CPU bus. Therefore, in image processing systems, the efficiency in the DMA transfer affects the bus performance, and the bus performance affects the performance of the entire system.

FIG. 20 is a diagram illustrating a construction of a conventional image processing system which performs processing of a great amount of data. In the system of FIG. 20, a memory unit 910 and a plurality of data processing units 920, 930, 940, . . . are connected through a CPU bus 901, and a bus controller 902 performs arbitration between requests for use of the CPU bus 901.

The memory unit 910 includes a memory controller 911 and a DRAM (Dynamic Random Access Memory) 912. The memory controller 911 controls operations of writing data in the DRAM 912 and reading data from the DRAM 912. The DRAM 912 stores data used by the data processing units 920, 930, 940, . . . .

The data processing unit 920 includes a processor element 921, SRAMs (Static Random Access Memories) 922 and 923, a memory interface (I/F) unit 924, and a PE-DMAC (processor-element DMA controller) 925. The processor element 921 performs processing of data by using the SRAMs 922 and 923. Data used by the processor element 921 and results of the processing performed by the processor element 921 are stored in the SRAMs 922 and 923. The memory interface unit 924 performs operations of writing data in the SRAMs 922 and 923 and reading data from the SRAMs 922 and 923. The PE-DMAC 925 controls DMA operations when the memory interface unit 924 performs data transfer through the CPU bus 901.

The data processing unit 930 includes a processor element 931, SRAMs 932 and 933, a memory interface (I/F) unit 934, and a PE-DMAC (processor-element DMA controller) 935, which have respectively similar functions to the processor element 921, the SRAMs 922 and 923, the memory interface unit 924, and the PE-DMAC 925. In addition, the data processing unit 940 includes a processor element 941, SRAMs 942 and 943, a memory interface (I/F) unit 944, and a PE-DMAC (processor-element DMA controller) 945, which have respectively similar functions to the processor element 921, the SRAMs 922 and 923, the memory interface unit 924, and the PE-DMAC 925.

FIG. 21 is a timing diagram indicating timings of read-access operations in the conventional system. FIG. 21 shows examples of operations performed when the PE-DMAC 925 outputs a request (read-transfer request) to read data from the memory unit 910.

When the PE-DMAC 925 outputs a read-transfer request (indicated as “Read req” in FIG. 21), the bus controller 902 for the CPU bus 901 performs bus arbitration. When the read-transfer request is granted, the PE-DMAC 925 makes a status judgment about information necessary for reading data (i.e., determines the information necessary for reading data), and sends the information to the memory controller 911.

The memory controller 911 performs arbitration between the above read-transfer request and other requests (which is indicated as “Req arbitration” in FIG. 21), and thereafter performs a read access to the DRAM 912. Data read out from the DRAM 912 are transferred to the PE-DMAC 925 through the CPU bus 901.

The DMA transfer performed in the above-described manner is repeated. In addition, the plurality of data processing units 920, 930, 940, . . . are provided in order to realize real-time processing. Therefore, the data processing units 920, 930, 940, . . . frequently access the memory unit 910. In this situation, some techniques have been proposed for maximizing the efficiency in data transfer through the CPU bus 901.

For example, according to a technique as disclosed in Japanese Unexamined Patent Publication No. 2001-022637, in order to prevent transfer of unnecessary data, the memory controller 911 stores data read out from the DRAM 912, in a buffer, and transfers only necessary data from the buffer through the CPU bus 901.

In addition, the DMA transfer is performed in the burst transfer mode in order to increase the transfer efficiency. However, when a fault occurs during the burst transfer, information on the fault is not sent until the burst transfer is completed. In order to solve this problem, a technique is disclosed in, for example, Japanese Unexamined Patent Publication No. 7-219888. According to this technique, a Pio bus for transferring information on a fault is arranged separately from the CPU bus for DMA transfer, so that the information on the fault can be obtained during the DMA transfer.

An example of the bus connection systems which can be applied to the system having the construction as illustrated in FIG. 20 is the AMBA (Advanced Microcontroller Bus Architecture) bus system. In particular, the AMBA AHB (Advanced High-performance Bus) system is most widely used, and use of the AMBA AXI (Advanced extensible Interface) system is widely spreading as the newest system. (See “AMBA Home Page,” ARM Limited, http://www.arm.com/products/solutions/AMBAHomePage.html (accessed by the applicant on Dec. 7, 2005)).

However, when DMA transfer is performed through a CPU bus, the CPU bus is uselessly occupied in a substantial number of cycles during execution of a request to read and transfer data (read-transfer request), so that the efficiency in the DMA transfer decreases. Hereinbelow, the reasons for the decrease in the efficiency in the DMA transfer are indicated.

As mentioned before, the performance of the image processing system which processes a great amount of data depends on the efficiency in the DMA transfer. Although the bit width of the bus and the operational frequency are important factors which affect the efficiency in the DMA transfer, the efficiency in the DMA transfer is not determined by only the bit width of the bus and the operational frequency.

In many cases, when a right of use of a bus is obtained, the amount of data which can be transferred before the right of use is released (i.e., the maximum transferable data size) is limited by a bus specification. This is because if a bus is occupied for a long time by a data transfer performed in response to a request from one of a plurality of sources of data-transfer requests (e.g., a plurality of devices which output a request to transfer data), data transfers in response to requests from the other sources of data-transfer requests are impeded, so that processing to be performed by the other sources of data-transfer requests is delayed, and the real-time performance of the processing performed by the other sources of data-transfer requests is likely to be impaired. In order to overcome the above problem, conventionally, the maximum transferable data size is limited when a right of use of a bus is obtained, and data to be transferred is divided into a plurality of pieces before transfer, so that data transfer for each data-transfer-request source can be interrupted by other sources of data-transfer requests.

In practice, bus arbitration based on priorities assigned to the plurality of sources of data-transfer requests determines whether or not to allow an interruption by another data-transfer-request source. Every data transfer sequence includes a bus arbitration cycle in the initial stage. Therefore, the division of the data to be transferred lowers the efficiency in the DMA transfer.

Consider a case where a data-transfer-request source outputs a read-transfer request to read and transfer a substantial amount of data. In order to limit the maximum size of data which can be transferred in a single transfer operation, the maximum transferable data size is predetermined in a bus specification. In the case where the DMA controller receives a read-transfer request to read and transfer data the amount of which exceeds the maximum transferable data size, the DMA controller automatically divides the received read-transfer request into a plurality of read-transfer requests in such a manner that the size of data transferred in response to each of the plurality of read-transfer requests does not exceed the maximum transferable data size. Then, the DMA controller outputs each of the plurality of read-transfer requests onto the bus. Thus, it is possible to prevent an operation of transferring data the amount of which exceeds the maximum transferable data size.

The operation of reading and transferring data in response to each of the plurality of read-transfer requests is performed in the following sequence.

(A) A PE-DMAC outputs a read-transfer request (indicated as “Read req” in FIGS. 20 and 21) onto the CPU bus, and acquires a right of use of the CPU bus.

(B) The PE-DMAC sends to the memory controller address information including a start address (indicated as “start, adr” in FIG. 21), the data length (indicated as “data_length” in FIG. 21), and the like for the data to be read and transferred.

(C) The memory controller reads out data from the memory (DRAM).

(D) The memory controller outputs data onto the CPU bus. After the data are transferred to a desired memory, the memory controller releases the right of use of the CPU bus, and outputs an access-completion signal (indicated as “end” in FIG. 21) to the PE-DMAC.

In the case where an original read-transfer request to read and transfer data is divided into a plurality of read-transfer requests, it is impossible to start the above operation (A) in the next sequence until the operation (D) in the current sequence is completed. Therefore, while the operations (A) to (C) are performed, the CPU bus is occupied although no data is actually transferred through the CPU bus. Thus, the efficiency in the DMA transfer is seriously lowered.

In the AMBA AXI system, a data-transfer-request bus and a data-transfer bus are separately arranged, so that more than one data-transfer request can be multiply issued. Specifically, the operations (A) and (B) handling a data-transfer request are performed by using the data-transfer-request bus, and the data transfer in the operation (D) is performed by using the data-transfer bus, which is arranged separately from the data-transfer bus. Thus, the operations (A) and (B) can be performed in parallel with the operation (D). That is, in the case where a multilayer bus structure is used, it is possible to multiply issue read-transfer requests.

In order to multiply issue read-transfer requests, it is necessary to memorize the state in which the read- transfer requests are multiply issued. Further, in order to memorize such a state, memory circuits the number of which corresponds to the multiplicity of the read-transfer requests are necessary, so that the circuit size increases. Therefore, in practice, the multiplicity of the requests is limited. However, in the AMBA AXI system, the multiplicity of requests is arbitrary. In addition, the AMBA AXI system also allows a bus structure in which multiple read-transfer requests cannot coexist. In such a case, the efficiency in the DMA transfer in the AMBA AXI system can be equivalent to the efficiency in the DMA transfer in the AMBA AHB system. Further, in some cases, the specifications of installed processor cores do not allow use of a multilayer bus structure as in the AMBA AXI system, so that the efficiency in the DMA transfer cannot be increased.

Incidentally, the improvement of the processor performance by increase in the operational frequency is currently approaching its limit. In the past, it was possible to increase the operation speed by reducing the sizes of transistors. However, after the line width reaches 100 nm, the operational frequency is also approaching its limit. Therefore, even the sizes of transistors are further reduced, no effect other than the size reduction can be expected.

In order to improve the performance in the above circumstances, multicore processors in which a plurality of processor cores are built in a single chip are becoming mainstream. Since the multicore-processor systems have a plurality of sources of data-transfer requests, the increase in the efficiency in the DMA transfer is an important factor for improvement of the performance.

As mentioned before, a great amount of data is processed in the image processing. There is a problem which relates to improvement in the data transfer efficiency in the image processing and is specific to the image processing.

In the image processing, usually, access to a two-dimensional rectangular area is supported by a DMA transfer system. For example, access to a two-dimensional rectangular area is effective for transferring data of a rectangular area of a screen from a frame memory to another memory.

When a two-dimensional rectangular area is accessed, the addresses of the two-dimensional rectangular area in a source-side memory (from which data of the two-dimensional rectangular area are to be read out) are successive in the horizontal direction, and discrete in the vertical direction. On the other hand, in many cases, the data of the two-dimensional rectangular area are written at consecutive addresses in a destination-side memory, i.e., the destination-side memory is one-dimensionally accessed. Therefore, in such a case, usually the two-dimensional rectangular area is divided into stripe areas respectively corresponding to horizontal lines, and a plurality of read-transfer requests are issued.

However, it is well known that the data transfer efficiency through a bus increases with the burst length. For example, the total number of cycles required in the case where bus arbitration is performed once for a single burst transfer of 160 bytes of data is smaller than the total number of cycles required in the case where bus arbitration is performed ten times for ten burst transfers of 16 bytes of data, by the number of cycles necessary for performing the bus arbitration nine times. For example, in the case where the bus width is 64 bits (8 bytes), and it takes one cycle to perform bus arbitration (i.e., each bus arbitration cycle is one cycle), the bus transfer efficiency (i.e., the average amount of data transferred in a cycle) becomes as follows.

In the case where bus arbitration is performed once for a single burst transfer of 160 bytes of data, the bus transfer efficiency is 7.62 bytes/cycle {=160÷(160÷8+1)}. On the other hand, in the case where bus arbitration is performed ten times for ten burst transfers of 16 bytes of data, the bus transfer efficiency is 5.33 bytes/cycle [=160÷{(16÷8+1)×10}]. That is, the bus transfer efficiency decreases by approximately 30% {=(7.62−5.33)/7.62}. This indicates that when the amount of transferred data in each of the plurality of burst transfers is small, the bus arbitration cycles increased by the division becomes unignorable.

However, in the image processing, the horizontal dimension of a two-dimensional rectangular area the data of which are DMA transferred when the two-dimensional rectangular area is accessed is as small as, for example, 32 to 64 pixels. Further, currently, the bus widths in the image processing systems are being increased beyond 64 bits (8 bytes) since transfer of a great amount of data is required in many image processing applications. Therefore, the data transfer efficiency in the case where the burst length in data transfer is small is further lowered.

### SUMMARY OF THE INVENTION

The present invention is made in view of the above problems, and the object of the present invention is to provide a data processing apparatus which exhibits high efficiency in data transfer performed in response to a read-transfer request.

In order to accomplish the above object, according to the present invention, a data processing apparatus is provided. The data processing apparatus comprises a data processing unit, a data management unit, a bus, and a dedicated line. The bus connects the data processing unit and the data management unit for use in DMA transfer between the data processing unit and the data management unit. The dedicated line connects the data processing unit and the data management unit for use in transmission of a first request for DMA transfer. The data processing unit includes a processor, a receiver-side DMA controller, and a data storage area. The data management unit manages data, and includes a memory controller, a transmitter-side DMA controller, a buffer, and a memory which stores the data. The whole or a part of the data is designated in the first request. The receiver-side DMA controller outputs the first request through the dedicated line when the processor outputs a second request to read the whole or the part of the data. The transmitter-side DMA controller receives through the dedicated line the first request outputted from the receiver-side DMA controller, outputs a third request to read from the memory the whole or the part of the data designated by the first request, and acquires a right of use of the bus and outputs a fourth request to transfer the whole or the part of the data through the bus by DMA and write the whole or the part of the data in the data storage area when the whole or the part of the data is stored in the buffer. The memory controller reads out the whole or the part of the data from the memory and stores the whole or the part of the data in the buffer when the third request is outputted from the receiver-side DMA controller, and transfers the whole or the part of the data from the buffer through the bus by DMA so as to write the whole or the part of the data in the data storage area in the data processing unit when the transmitter-side DMA controller outputs the fourth request.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

FIG. 1 is a conceptual diagram of a data processing apparatus according to the present invention.

FIG. 2 is a diagram illustrating an example of a construction of an LSI according to a first embodiment of the present invention.

FIG. 3 is a block diagram indicating the internal constructions of the data processing unit and the memory unit and information passed between the elements of the LSI according to the first embodiment.

FIG. 4 is a diagram indicating information passed between the elements of the LSI according to the first embodiment during execution of a read-transfer request outputted from the data processing unit.

FIG. 5 is a timing diagram indicating timings of operations for reading data from a shared memory in the first embodiment.

FIG. 6 is a timing diagram indicating timings of operations for divisionally transferring data.

FIG. 7 is a diagram illustrating an example of a construction of an LSI for image processing according to a second embodiment of the present invention.

FIG. 8 is a block diagram illustrating internal constructions of a memory interface and an image processing engine and information passed between the elements of the LSI according to the second embodiment.

FIGS. 9A and 9B are diagrams illustrating examples of manners of transferring data divided into pieces each having a length equal to one-half the data width in the transfer.

FIGS. 10A and 10B are diagrams illustrating examples of manners of transferring data which are divided into pieces each having a length equal to 1.5 times the data width in the transfer.

FIG. 11 is a flow diagram indicating processing performed by a first sequencer in a DMA controller (MEM-DMAC).

FIG. 12 is a flow diagram indicating processing performed by a second sequencer in the DMA controller (MEM-DMAC).

FIG. 13 is a flow diagram indicating processing performed by a first sequencer in a memory controller.

FIG. 14 is a flow diagram indicating processing performed by a second sequencer in the memory controller.

FIG. 15 is a timing diagram indicating timings of operations performed in the case where data divided into pieces are transferred, and each piece has a length equal to one-half the data width in the transfer.

FIG. 16 is a timing diagram indicating timings of operations performed in the case where data divided into pieces are transferred, and each piece has a length equal to 1.5 times the data width in the transfer.

FIG. 17 is a timing diagram indicating timings of operations performed in the case where data divided into pieces are transferred, and each piece has a length equal to 5/4 times the data width in the transfer.

FIG. 18 is a timing diagram of pipeline processing.

FIG. 19 is a timing diagram indicating timings of pipeline processing of a request from a DMA controller (PE-DMAC).

FIG. 20 is a diagram illustrating a construction of a conventional image processing system.

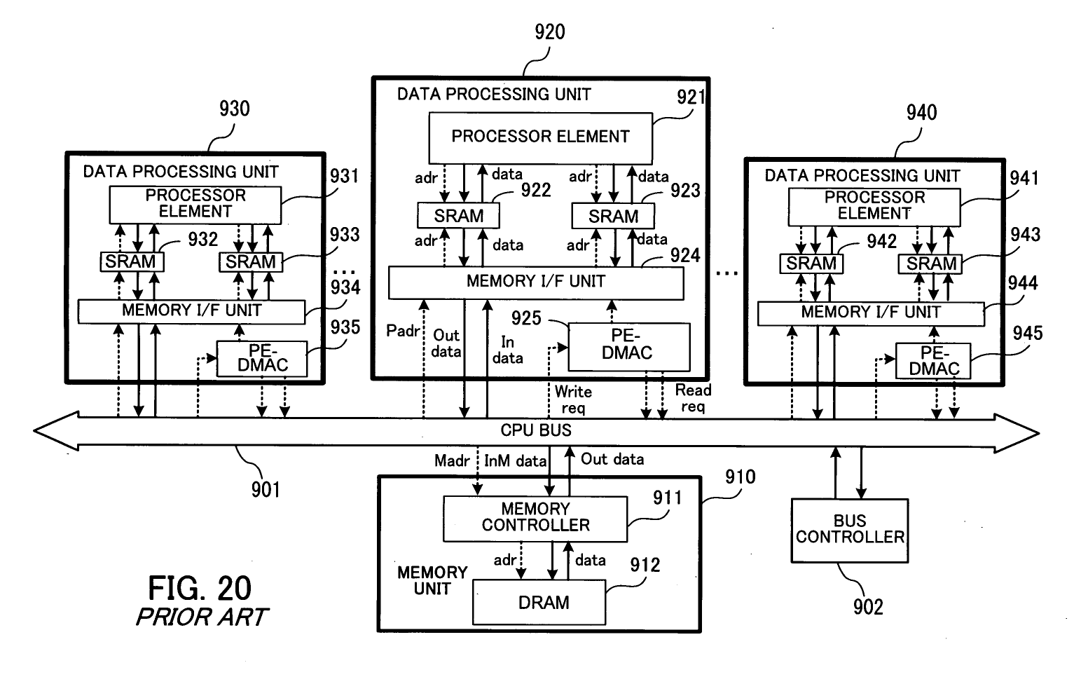

FIG. 21 is a timing diagram indicating timings of read-access operations in the conventional system.

### DESCRIPTION OF THE PREFERRED EMBODIMENTS

Preferred embodiments of the present invention will be explained below with reference to the accompanying drawings, wherein like reference numbers refer to like elements throughout.

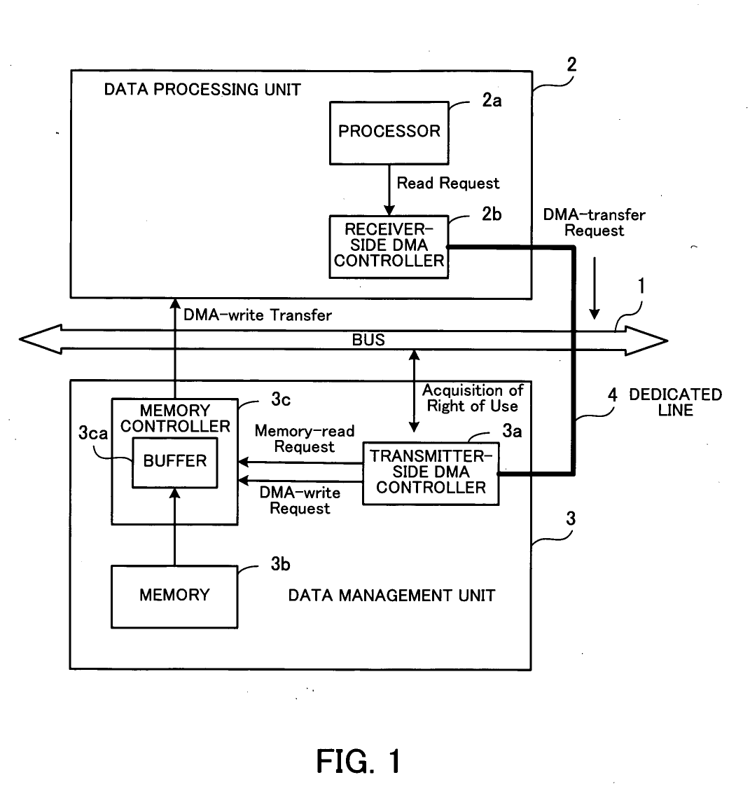

FIG. 1 is a conceptual diagram of a data processing apparatus according to the present invention. In the data processing apparatus illustrated in FIG. 1, a data processing unit 2 and a data management unit 3 are connected through a bus 1. The data processing unit 2 comprises a processor 2a and a receiver-side DMA controller 2b. The data management unit 3 comprises a transmitter-side DMA controller 3a, a memory 3b, and a memory controller 3c. The receiver-side DMA controller 2b in the data processing unit 2 is connected to the transmitter-side DMA controller 3a in the data management unit 3 through a dedicated line 4. The dedicated line 4 is used for transmitting a request for DMA transfer (DMA-transfer request).

The processor 2a in the data processing unit 2 performs data processing. When the data processing unit 2 needs data which are stored in the memory 3b managed by the data management unit 3 during the data processing, the data processing unit 2 outputs to the receiver-side DMA controller 2b a request (read request) to read the necessary data.

When the read request is outputted from the processor 2a, the receiver-side DMA controller 2b in the data processing unit 2 outputs a DMA-transfer request through the dedicated line 4 to the transmitter-side DMA controller 3a in the data management unit 3. At this time, the DMA-transfer request contains information designating data to be transferred (e.g., addresses and data length) and information designating a data storage area in the data processing unit 2 in which the transferred data are to be written (e.g., a destination address).

The transmitter-side DMA controller 3a in the data management unit 3 receives through the dedicated line 4 the DMA-transfer request outputted from the receiver-side DMA controller 2b, and outputs to the memory controller 3c a request (memory-read request) to read the data designated by the DMA-transfer request. In addition, when the data are stored in a buffer 3ca, the transmitter-side DMA controller 3a acquires a right of use of the bus 1, and outputs to the memory controller 3c a request (DMA-write request) to transfer the data by DMA and write the data.

When the read request is outputted from the transmitter-side DMA controller 3a, the memory controller 3c in the data management unit 3 receives the data designated by the DMA-transfer request, from the memory 3b (which is managed by the data management unit 3), and stores the data in the buffer 3ca. In addition, when the DMA-write request is outputted from the transmitter-side DMA controller 3a, the memory controller 3c transfers the data (stored in the buffer 3ca) through the bus 1 by DMA, and writes the transferred data in the designated data storage area in the data processing unit 2 (performs a DMA write of the data stored in the buffer 3ca).

That is, in the data processing apparatus having the construction explained above, when the processor 2a in the data processing unit 2 outputs a read request to read data managed by the data management unit 3, the receiver-side DMA controller 2b outputs a DMA-transfer request from the data processing unit 2 to the data management unit 3 through the dedicated line 4. In response to the DMA-transfer request, the transmitter-side DMA controller 3a in the data management unit 3 outputs a memory-read request. Then, the memory controller 3c reads out the data designated in the DMA-transfer request, from the memory 3b managed by the data management unit 3, and stores the data in the buffer 3ca. When the data are stored in the buffer 3ca, the transmitter-side DMA controller 3a acquires a right of use of the bus 1, and outputs a DMA-write request, and then the memory controller 3c transfers the data (stored in the buffer 3ca) through the bus 1 by DMA, and writes the data in the designated data storage area in the data processing unit 2 (i.e., performs a DMA-write operation).

In the operations explained above, the efficiency in the processing of a read-transfer request by DMA is increased. The simplest way to increase the efficiency in the DMA transfer independently of the bus specification is to realize the DMA data transfer by only the write transfer. The operations performed in response to a write-transfer request are explained below.

Generally, when a need to transfer a substantial amount of data arises, it is necessary to generate a plurality of write-transfer requests. In the operation performed in response to a write-transfer request, the source of the request (i.e., a device in which the request is generated) reads out data from a memory the access control of which is directly performed by the source of the request, and transfers the data to a destination. At this time, the addresses used for reading out the data from the memory are held in a DMA-transfer controller in-the source of the request. Even in the case where the plurality of write-transfer requests are generated, the addresses used for successively reading out data from the memory are held in controllers in the sources of the plurality of write-transfer requests, and the operations before data transfer through a bus are not affected by the bus specification. That is, the write transfer requests inherently have the possibility of being efficiently executed.

As indicated above, it is effective to realize the DMA data transfer by only the write transfer. However, when the source of the request cannot read out data from other memories, it is impossible to perform desired processing, and therefore an alternative measure is necessary. According to the present invention, the dedicated line 4 is provided for sending the DMA-transfer request from the data processing unit 2 to the data management unit 3, so that the data management unit 3 can receive the DMA-transfer request for data needed by the data processing unit 2 without use of the bus 1. When the data to be transferred are designated in the DMA-transfer request, the data management unit 3 can read out the data, store the data in the buffer 3ca, acquire a right of use of the bus 1, and perform a write transfer of the data by DMA. Hereinbelow, details of the embodiments of the present invention are explained.

### First Embodiment

In the first embodiment, an example of an LSI (Large Scale Integrated Circuit) which performs processing of a great amount of data in real time is presented.

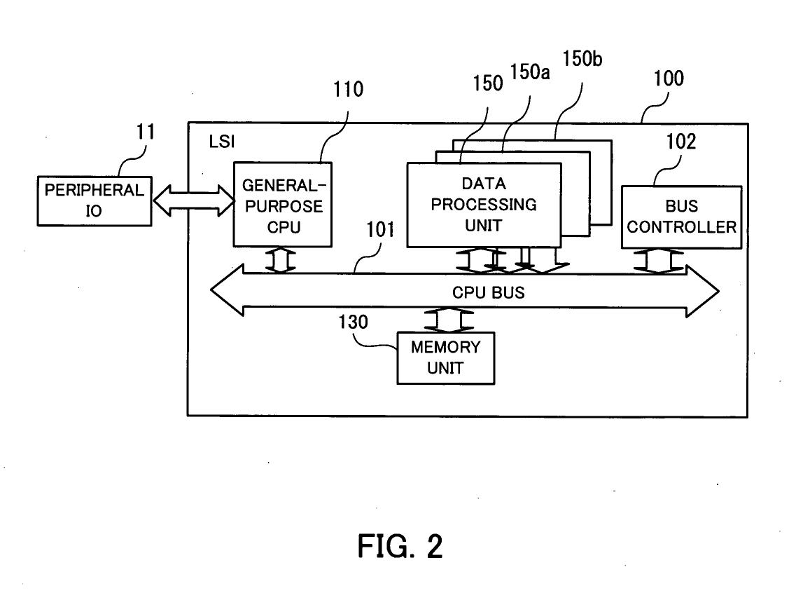

FIG. 2 is a diagram illustrating an example of a construction of an LSI as the first embodiment of the present invention. The LSI 100 comprises a CPU bus 101 controlled by a bus controller 102. In addition, a general-purpose CPU 110, a memory unit 130, and a plurality of data processing units 150, 150a, 150b, . . . are connected to the CPU bus 101.

The general-purpose CPU 110 performs various data processing. In addition, a peripheral IO (input/output) interface 11 is connected to the general-purpose CPU 110, so that the general-purpose CPU 110 can receive and output data through the peripheral IO interface 11.

The memory unit 130 contains a DRAM. The memory unit 130 writes and reads data in and from the DRAM, and performs data transfer through the CPU bus 101.

The data processing units 150, 150a, 150b, . . . perform image processing in real time. The data processing units 150, 150a, 150b, . . . acquire image data to be processed, from the memory unit 130 through the CPU bus 101, and transfer the results of the processing of the image data to the memory unit 130 through the CPU bus 101.

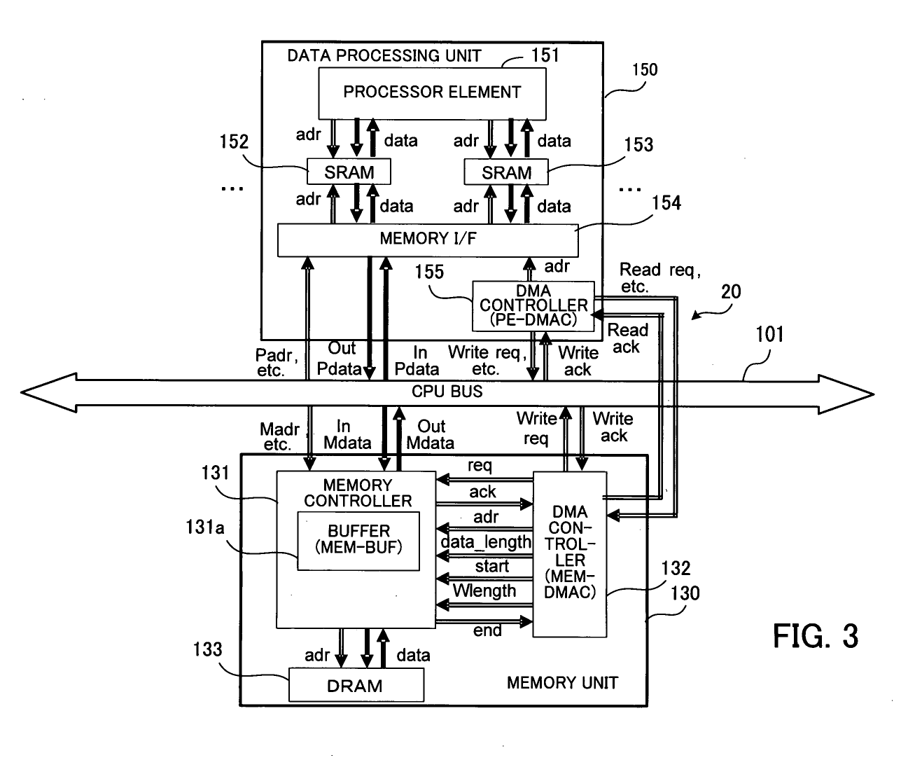

FIG. 3 is a block diagram indicating the internal constructions of the memory unit 130 and the data processing unit 150 and information passed between the elements of the LSI according to the first embodiment. The memory unit 130 comprises a memory controller 131, a DMA controller (MEM-DMAC) 132, and the DRAM 133.

The memory controller 131 contains an internal buffer (MEM-BUF) 131a. The memory controller 131 is connected to the CPU bus 101 and to the DRAM 133 through signal lines having a very wide bandwidth. The memory controller 131 writes and reads data in and from the DRAM 133, and performs data transfer through the CPU bus 101.

When DMA transfer is performed, the memory controller 131 operates in accordance with an instruction from the MEM-DMAC 132. At this time, data to be transferred to the data processing unit 150 are read out from the DRAM 133, and stored in the MEM-BUF 131a. Then, only necessary portions of the data are read out from the MEM-BUF 131a, and transferred to the data processing unit 150.

The MEM-DMAC 132 is connected to the data processing unit 150 through dedicated lines 20 for transmitting a read-transfer request (which corresponds to the aforementioned DMA-transfer request in FIG. 1). Although only the dedicated lines 20 connected to the data processing unit 150 are indicated in FIG. 3, the MEM-DMAC 132 is also connected to each of the other data processing units 150a, 150b, . . . through similar dedicated lines for transmitting a read-transfer request. The MEM-DMAC 132 controls DMA transfer of data from the DRAM 133 to the data processing unit 150 in response to a read-transfer request which is sent from the data processing unit 150 through the dedicated lines 20.

The data processing unit 150 comprises a processor element 151, SRAMs 152 and 153, a memory interface (I/F) 154, and a DMA controller (PE-DMAC) 155.

The processor element 151 performs image processing. The processor element 151 is connected to the two SRAMs 152 and 153, reads out image data to be processed, from the SRAMs 152 and 153, and writes the results of the processing of the image data in the SRAMs 152 and 153.

The SRAMs 152 and 153 are storage devices provided for storing image data to be processed and results of processing. While data are written in each of the SRAMs 152 and 153, other data are read out from the other of the SRAMs 152 and 153.

The memory interface 154 receives data through the CPU bus 101, and stores the received data in the SRAMs 152 and 153. In addition, the memory interface 154 transfers data stored in the SRAMs 152 and 153 to the memory unit 130 through the CPU bus 101. Further, the memory interface 154 performs processing for DMA transfer in accordance with an instruction from the PE-DMAC 155.

The PE-DMAC 155 controls the processing for DMA transfer. The dedicated lines 20 for transmitting a read-transfer request (DMA-transfer request) are connected to the PE-DMAC 155, so that the PE-DMAC 155 can send a read-transfer request (DMA-transfer request) to the MEM-DMAC 132 in the memory unit 130 through the dedicated lines 20.

As described above, according to the first embodiment of the present invention, the MEM-DMAC 132 is provided in the memory unit 130 for handling a read-transfer request (DMA-transfer request), and the dedicated lines 20 are provided for receiving the read-transfer request from the source of the DMA-transfer request. Thus, DMA transfer is performed as follows.

When a request (read-transfer request) for a read transfer by DMA is set in the data processing unit 150, the PE-DMAC 155 does not output the request onto the CPU bus 101, and instead sends information on the read-transfer request, through the dedicated lines 20 to the MEM-DMAC 132 in the memory unit 130. Then, the MEM-DMAC 132 sends to the memory controller 131 a request for access to the memory (memory-access request) in accordance with the received information on the read-transfer request. In response to the memory-access request, the memory controller 131 reads out data from the memory (the DRAM 133), and stores the data in the MEM-BUF 131a. Then, the MEM-DMAC 132 sends a write-transfer request to the CPU bus 101. At this time, the MEM-DMAC 132 divides the transfer operation into a plurality of transfers on the basis of a bus specification. Thus, all the data transfer operations through the CPU bus 101 by DMA can be realized by write-transfer operations, and the CPU bus 101 can be efficiently used.

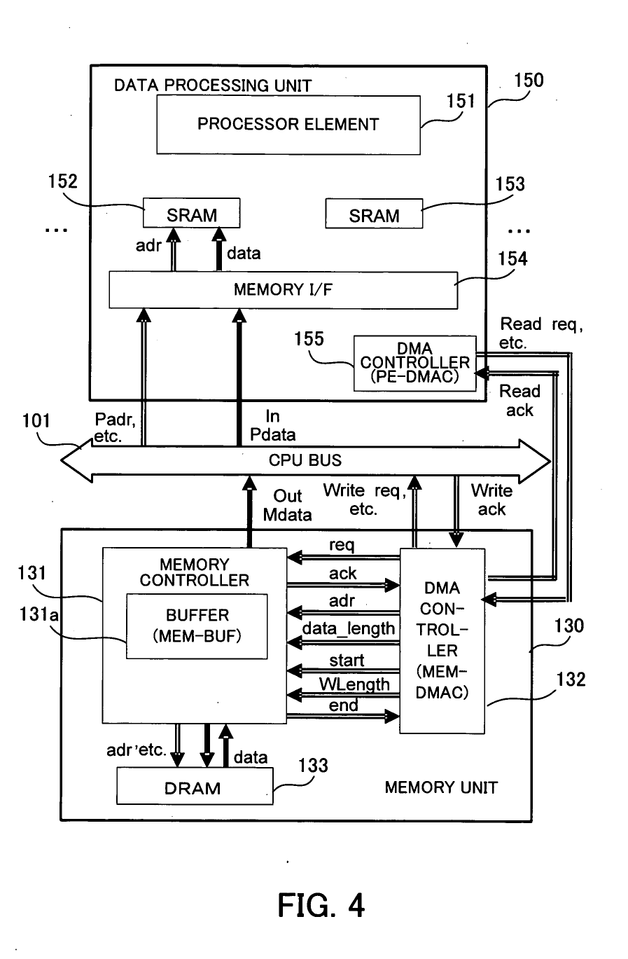

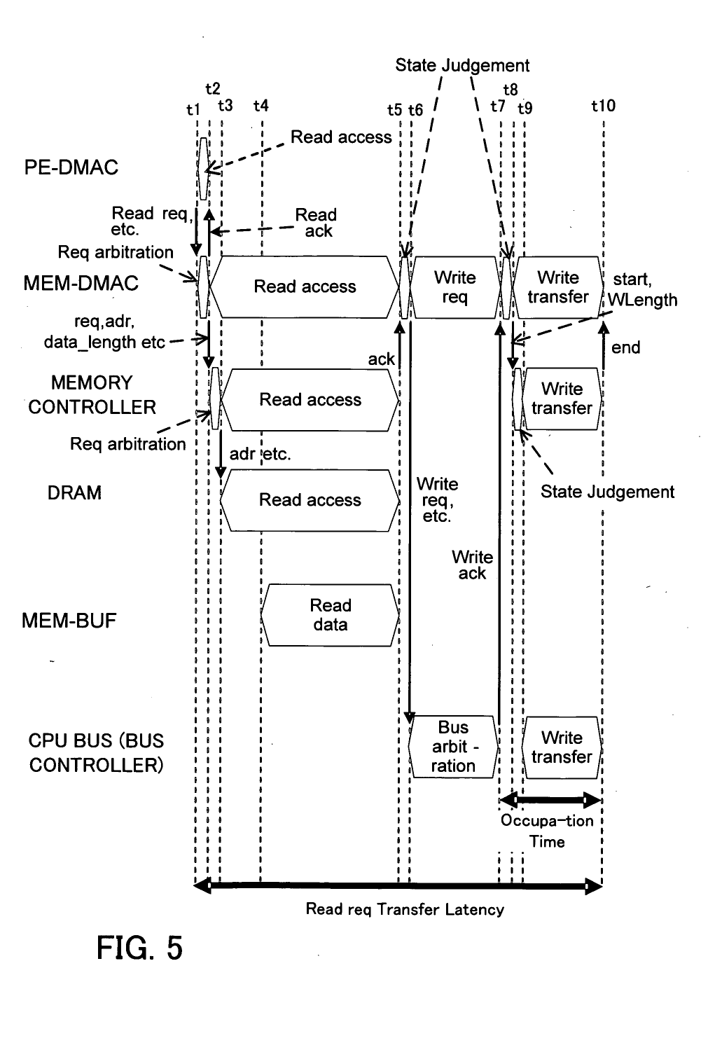

Hereinbelow, the operations of the respective elements of the LSI according to the first embodiment including exchange of information between the elements are explained with reference to FIGS. 4 and 5.

FIG. 4 is a diagram indicating information passed between the elements of the LSI according to the first embodiment during execution of a read-transfer request outputted from the data processing unit, and FIG. 5 is a timing diagram indicating timings of operations for reading data from the shared memory (the DRAM 133) in the first embodiment. In this example, it is assumed that the read-transfer request requests a one-dimensional transfer, the operation of reading data from the DRAM 133 is completed by one burst access operation, and the length of data transferred through the CPU bus 101 does not exceed the maximum data length limited by the specification of the CPU bus 101.

In the timing diagram of FIG. 5, the operations of the DMA controller (PE-DMAC) 155 in the data processing unit 150, the DMA controller (MEM-DMAC) 132, the memory controller 131, and the DRAM 133 in the memory unit 130, the MEM-BUF 131a in the memory controller 131, and the CPU bus 101 (with the bus controller 102) are indicated in chronological order.

First, at time t1, the PE-DMAC 155 in the data processing unit 150 starts read-access processing. In the read-access processing, the PE-DMAC 155 outputs a read-transfer request (indicated as “Read req” in FIGS. 4 and 5) through the dedicated lines 20 to the MEM-DMAC 132 in the memory unit 130. At this time, information necessary for DMA transfer (e.g., the start address, the data length, and the like of data to be read, and the destination address in the write transfer) is transferred together with the read-transfer request. Then, the MEM-DMAC 132 performs arbitration between the above read-transfer request and other requests (indicated as “Req arbitration” in FIGS. 4 and 5).

That is, the MEM-DMAC 132 determines whether or not the MEM-DMAC 132 can accept the read-transfer request from the PE-DMAC 155, on the basis of the current operational status. When yes is determined, the MEM-DMAC 132 makes preparations for the transfer in accordance with the received read-transfer request.

Specifically, the quantity of data remaining in the MEM-BUF 131a is checked in order to prevent mixture of data corresponding to the immediately preceding request and data corresponding to the request the acceptability of which is to be determined, in the MEM-BUF 131a. When no other data to be transferred remains in the MEM-BUF 131a, the MEM-DMAC 132 can accept the read-transfer request. When the MEM-DMAC 132 accepts the request, the MEM-DMAC 132 stores the information which is necessary for the DMA transfer.

In the example of FIG. 5, it is determined that the read-transfer request from the PE-DMAC 155 should be executed. In this case, the arbitration is completed at time t2, and the MEM-DMAC 132 returns an acknowledge signal (indicated as “Read ack” in FIGS. 4 and 5) through the dedicated lines 20 to the PE-DMAC 155. When the PE-DMAC 155 receives the acknowledge signal, the read-access processing in the PE-DMAC 155 is completed.

The MEM-DMAC 132 starts read-access processing at time t2. In the read-access processing, the MEM-DMAC 132 first outputs to the memory controller 131 an access request (indicated as “req” in FIGS. 4 and 5) for access to the DRAM 133. At the same time as the access request, the MEM-DMAC 132 outputs to the memory controller 131 the start address (indicated as “adr” in FIGS. 4 and 5) and the data length (indicated as “data_length” in FIGS. 4 and 5) of the data to be transferred. Then, the memory controller 131 performs arbitration between access requests (indicated as “Req arbitration” in FIGS. 4 and 5).

In the example of FIG. 5, at time t3, it is determined that a write request can be executed, and the memory controller 131 performs read-access processing for accessing the DRAM 133. In the read-access processing, the memory controller 131 reads out the data from the DRAM 133, where the data have the designated data length “data_length” and are stored at. the addresses of the DRAM 133 beginning from the designated start address. Specifically, the memory controller 131 successively outputs the addresses of the data to be read out, acquires the data outputted from the DRAM 133, and stores the data in the MEM-BUF 131a.

However, according to the specifications of the DRAM, when the DRAM 133 is accessed, the DRAM outputs the first data after a delay of several cycles. Therefore, in the example of FIG. 5, the operation of writing the data read out from the DRAM 133, into the MEM-BUF 131a is started at time t4.

At time t5, the operation of reading out the data from the DRAM 133 is completed. Then, the memory controller 131 outputs to the MEM-DMAC 132 an acknowledge signal (indicated as “ack” in FIGS. 4 and 5), which permits output of a write request. In response to the acknowledge signal “ack,” the MEM-DMAC 132 determines a state to which the memory unit 130 should transit next. In this case, the MEM-DMAC 132 recognizes that the data having the designated length has been stored in the MEM-BUF 131a, and determines that the memory unit 130 should transit to the state in which a write request is outputted. At time t6, the processing for the above determination is completed, and then the MEM-DMAC 132 outputs a write request (indicated as “Write req” in FIGS. 4 and 5) onto the CPU bus 101. At this time, the bus controller 102 receives the write request, and performs arbitration of a conflict between the above write request and requests from other devices (indicated as “Bus arbitration” in FIGS. 4 and 5).

The above arbitration is completed at time t7. Then, the bus controller 102 outputs a write acknowledge signal (indicated as “Write ack” in FIGS. 4 and 5) to the MEM-DMAC 132. In response to the write acknowledge signal “Write ack,” the MEM-DMAC 132 determines a state to which the memory unit 130 should transit next. In this case, the MEM-DMAC 132 recognizes that a right of use of the CPU bus 101 is acquired, and determines that the memory unit 130 should transit to the state in which write-transfer processing is performed. At time t8, the processing for the above determination is completed, and then the MEM-DMAC 132 outputs to the memory controller 131 a start signal (indicated as “start” in FIGS. 4 and 5) and a data size (indicated as “Wlength” in FIGS. 4 and 5) for the write transfer. Thereafter, the MEM-DMAC 132 controls write-transfer processing through the CPU bus 101 (indicated as “Write transfer” in FIGS. 4 and 5). The positions in which the data transferred by the write-transfer processing are to be written in the data processing unit 150 are designated by the data processing unit 150 on the basis of the write start address (indicated as “Padr” in FIG. 4).

When the memory controller 131 receives the start signal “start,” the memory controller 131 determines that the memory unit 130 should transit to the state in which write-transfer processing “Write transfer” (for transferring the data to the data processing unit 150 by DMA) is performed. At time t9, the processing for the above determination is completed, and then the memory controller 131 performs the write-transfer processing “Write transfer,” i.e., processing for a write transfer through the CPU bus 101 to the data processing unit 150 by DMA. Specifically, in response to the start signal “start” from the MEM-DMAC 132, the memory controller 131 outputs the data stored in the MEM-BUF 131a in advance, to the data processing unit 150 through the CPU bus 101, in unit lengths corresponding to the data width “Wlength.” The data (indicated as “Out Mdata” in FIG. 4) outputted from the memory controller 131 to the CPU bus 101 become input data (indicated as “In Pdata” in FIG. 4) of the memory interface 154 in the data processing unit 150, and are then written in the SRAM 152. Specifically, the memory interface 154 successively outputs to the SRAM 152 write addresses (indicated as “adr” in FIG. 4) beginning from the aforementioned write start address “Padr” so that the input data “In Pdata” are written at the write addresses in the SRAM 152.

At time t10, the above write-transfer processing is completed. Then, the memory controller 131 outputs an end signal (indicated as “end” in FIGS. 4 and 5) to the MEM-DMAC 132.

Although the transfer latency of the read-transfer request corresponds to the time interval from t1 to t10, the CPU bus 101 is occupied for only the duration from t7 to t10, as explained above. That is, the occupation time of the CPU bus 101 can be reduced. Therefore, it is possible to increase the overall efficiency in the data transfer through the CPU bus 101 in the entire system.

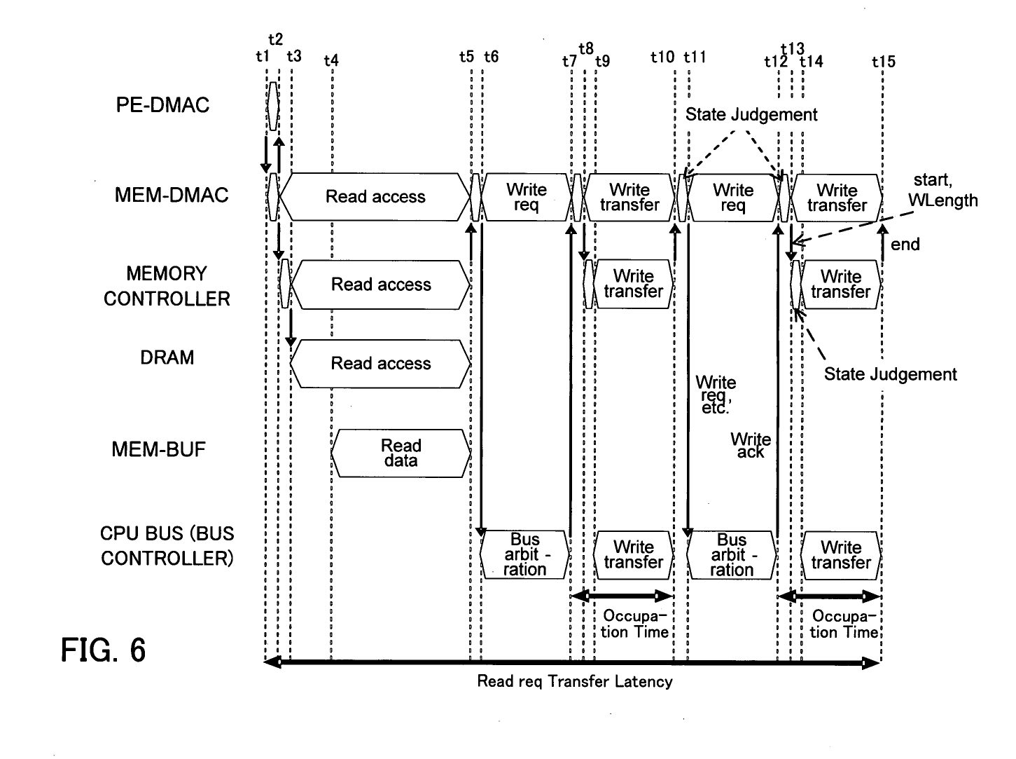

When the amount of the data to be transferred is greater than the transfer data size, the entire data is divided into a plurality of pieces, and transferred in a plurality of transfer operations. In this case, the operations performed in the timespan from t5 to t10 are repeated. FIG. 6 is a timing diagram indicating timings of operations for divisionally transferring data. The following explanations with reference to FIG. 6 are provided for an exemplary case where the maximum data length of M bytes is specified for the CPU bus 101, and the PE-DMAC 155 issues a read-transfer request “Read req” for a one-dimensional transfer of data having the data size of 2M bytes, and M is an integer greater than one. In addition, since the operations performed in the timespan from t1 to t10 in FIG. 6 are similar to the corresponding operations in FIG. 5, the explanations on the operations in FIG. 5 are not repeated.

When the first write-transfer operation is completed at time t10, the MEM-DMAC 132 calculates the amount of data remaining in the MEM-BUF 131a in the memory controller 131. In the above example, although the amount of data to be transferred is 2M bytes, only the first half (M bytes) of the data to be transferred has been transferred in the first write-transfer operation since the data length of the CPU bus 101 is limited by the maximum data length (M bytes). Therefore, the MEM-DMAC 132 recognizes that the second half (M bytes) of the data to be transferred remains in the MEM-BUF 131a. Then, the MEM-DMAC 132 determines that the memory unit 130 should transit to the state in which a write request “Write req” is outputted again, on the basis of the recognition of the remainder in the MEM-BUF 131a. At time t11, the processing for the above determination is completed, and then the MEM-DMAC 132 outputs a write request “Write req” onto the CPU bus 101. The bus controller 102 receives the write request, and performs arbitration between the above write request and requests from other devices (indicated as “Bus arbitration” in FIG. 6). When the use of the CPU bus 101 is granted by the arbitration, the bus controller 102 passes to the data processing unit 150 control data including the write start address “Padr” and the like.

The above arbitration is completed at time t12, and then the bus controller 102 outputs a write acknowledge signal (indicated as “Write ack” in FIG. 6) to the MEM-DMAC 132. In response to the write acknowledge signal “Write ack,” the MEM-DMAC 132 determines a state to which the memory unit 130 should transit next. In this case, the MEM-DMAC 132 recognizes that a right of use of the CPU bus 101 is acquired, and determines that the memory unit 130 should transit to the state in which write-transfer processing is performed. At time t13, the processing for the above determination is completed, and then the MEM-DMAC 132 outputs to the memory controller 131 a start signal (indicated as “start” in FIG. 6) and a data size “Wlength.” Thereafter, the MEM-DMAC 132 controls write-transfer processing (indicated as “Write transfer” in FIG. 6).

When the memory controller 131 receives the start signal “start,” the memory controller 131 determines that the memory unit 130 should transit to the state in which write-transfer processing “Write transfer” (for transferring the data to the data processing unit 150 by DMA) is performed. At time t14, the processing for the above determination is completed, and then the memory controller 131 performs the write-transfer processing “Write transfer,∞ i.e., processing for a write transfer through the CPU bus 101 to the data processing unit 150 by DMA. Specifically, in response to the start signal “start” from the MEM-DMAC 132, the memory controller 131 outputs the data which are stored in the MEM-BUF 131a and have not yet been transferred, through the CPU bus 101 to the data processing unit 150, where the outputted data have the length corresponding to the data width “Wlength.” The data “Out Mdata” outputted from the memory controller 131 to the CPU bus 101 become input data “In Pdata” of the memory interface 154 in the data processing unit 150, and are then written in the SRAM 152. Specifically, the memory interface 154 successively outputs to the SRAM 152 write addresses (indicated as “adr” in FIG. 6) beginning from the aforementioned write start address “Padr” so that the input data “In Pdata” are written at the write addresses in the SRAM 152.

At time t15, the above second write-transfer operation is completed. Then, the memory controller 131 outputs an end signal (indicated as “end” in FIG. 6) to the MEM-DMAC 132.

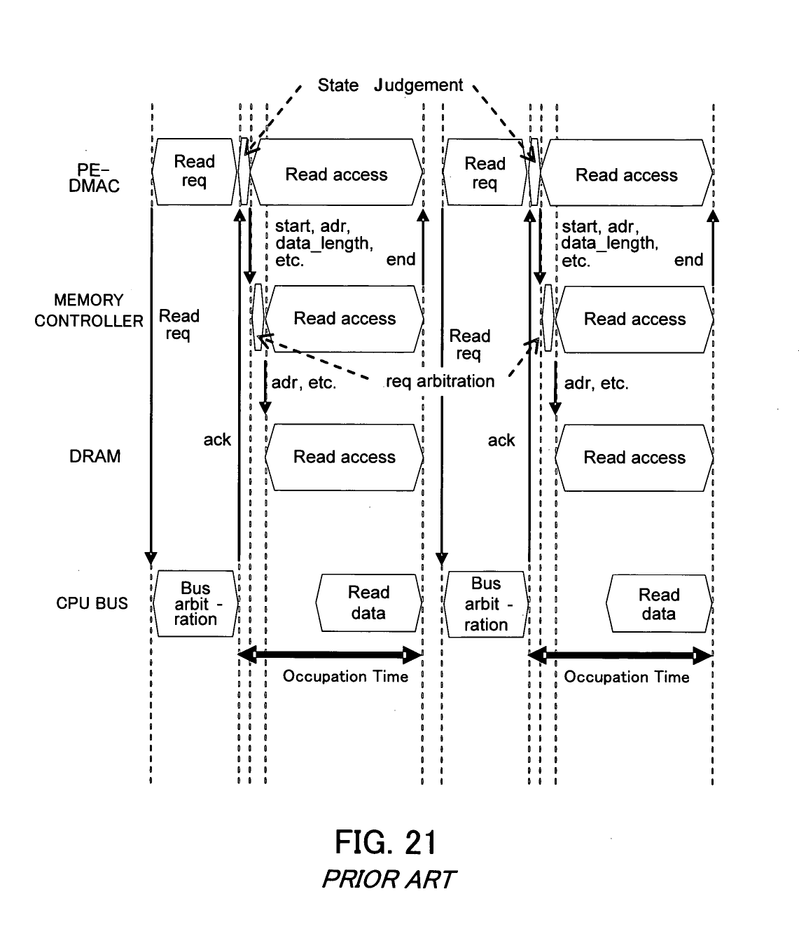

In the above example, the transfer latency of the read-transfer request corresponds to the time interval from t1 to t15. During the first and second write-transfer operations, the CPU bus 101 is occupied for the duration from t7 to t10 and the duration from t12 to t15, as explained above. That is, even in the case where data are transferred in more than one transfer operation, the occupation time of the CPU bus 101 can also be reduced, compared with the occupation time in the conventional processing (for example, in the processing of FIG. 21).

### Second Embodiment

Next, the second embodiment of the present invention is explained below. In the second embodiment, the present invention is applied to an LSI (Large Scale Integrated Circuit) for image processing. In order to handle image data, the LSI according to the second embodiment has a function of storing data read out from a two-dimensional rectangular area in a frame memory, at consecutive addresses.

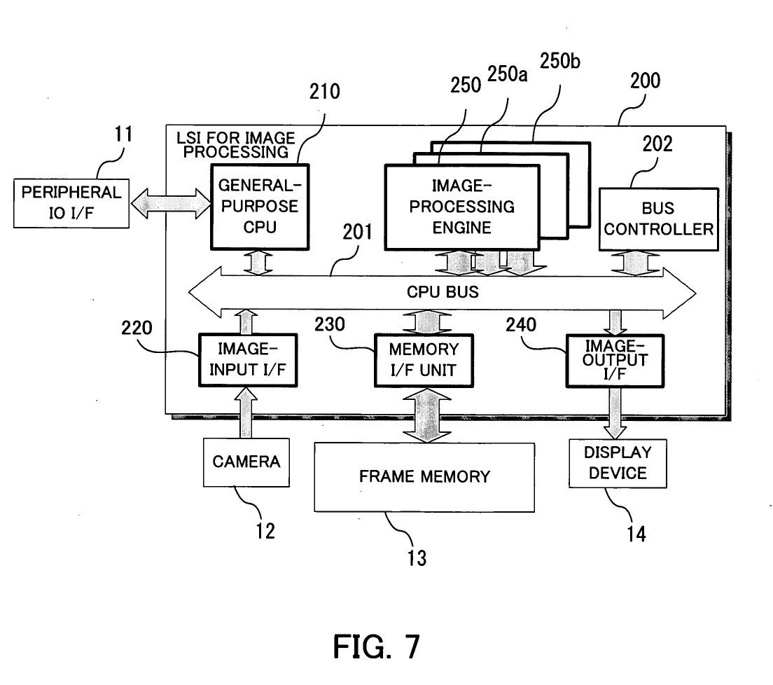

FIG. 7 is a diagram illustrating an example of a construction of the LSI for image processing according to the second embodiment of the present invention. The LSI 200 comprises a CPU bus 201 controlled by a bus controller 202. In addition, a general-purpose CPU 210, an image- input interface (I/F) 220, a memory interface (I/F) unit 230, an image-output interface (I/F) 240, and a plurality of image-processing engines 250, 250a, 250b, . . . are connected to the CPU bus 201.

The general-purpose CPU 210 performs various data processing. In addition, a peripheral IO (input/output) interface (I/F) 11 is connected to the general-purpose CPU 210, so that the general-purpose CPU 210 can receive and output data through the peripheral IO interface 11.

A camera 12 is connected to the image-input interface 220, which transfers image data sent from the camera 12, to the frame memory 13 or the like through the CPU bus 201. The frame memory 13 is connected to the memory interface unit 230. The frame memory 13 is a storage device which has a large capacity, and can be accessed at high speed. For example, the frame memory 13 is a DRAM. The memory interface unit 230 and the frame memory 13 are connected through signal lines having a very wide bandwidth. The memory interface unit 230 writes and reads data in and from the frame memory 13, and performs data transfer through the CPU bus 201.

A display device 14 is connected to the image-output interface 240, which receives image data through the CPU bus 201 and outputs the image data to the image device 14.

The image-processing engines 250, 250a, 250b, . . . perform image processing in real time. The image-processing engines 250, 250a, 250b, . . . acquire image data to be processed, from the frame memory 13 through the CPU bus 201, and transfer the results of the processing of the image data through the CPU bus 201 to the frame memory 13.

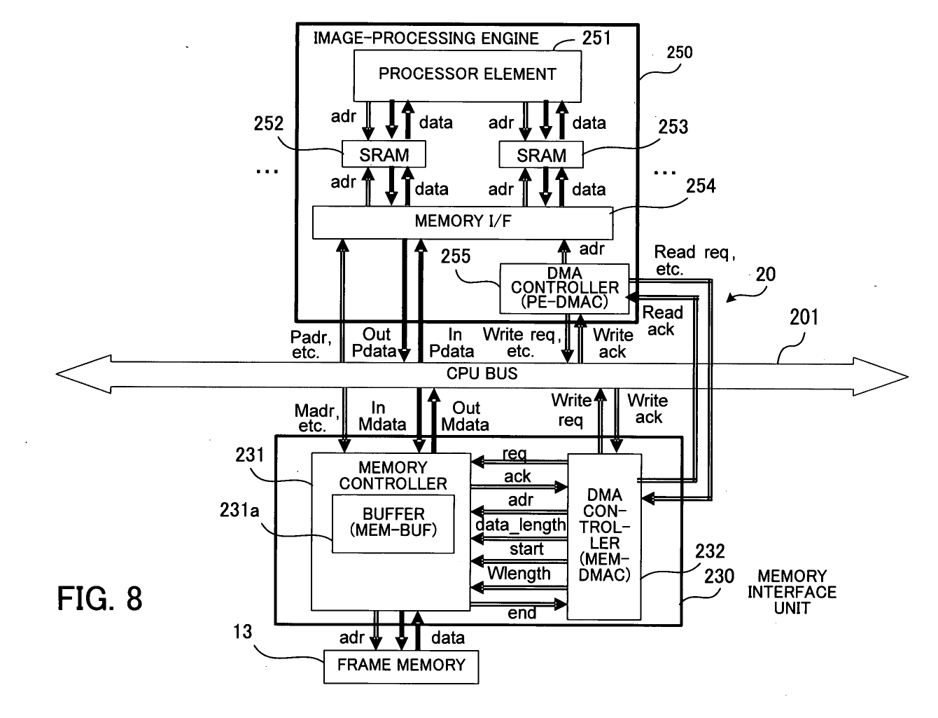

FIG. 8 is a block diagram internal constructions of the memory interface and one of the image processing engines and information passed between the elements of the LSI according to the second embodiment. The memory interface unit 230 comprises a memory controller 231 and a DMA controller (MEM-DMAC) 232.

The memory controller 231 contains an internal buffer (MEM-BUF) 231a. The memory controller 231 is connected to the CPU bus 201 and to the frame memory 13 through signal lines having a very wide bandwidth. The memory controller 231 writes and reads data in and from the frame memory 13, and performs data transfer through the CPU bus 201.

When DMA transfer is performed, the memory controller 231 operates in accordance with an instruction from the MEM-DMAC 232. At this time, data to be transferred to the image-processing engine 250 are read out from the frame memory 13, and stored in the MEM-BUF 231a. Then, only necessary portions of the data are read out from the MEM-BUF 231a, and transferred to the image-processing engine 250.

The MEM-DMAC 232 is connected to the image-processing engine 250 through dedicated lines 20 for transmitting a read-transfer request (which corresponds to the aforementioned DMA-transfer request in FIG. 1). Although only the dedicated lines 20 connected to the image-processing engine 250 are indicated in FIG. 8, the MEM-DMAC 232 is also connected to each of the other image-processing engines 250a, 250b, . . . through similar dedicated lines for transmitting a read-transfer request.

The MEM-DMAC 232 controls DMA transfer of data from the frame memory 13 to the image-processing engine 250 in response to a read-transfer request which is sent from the image-processing engine 250 through the dedicated lines 20.

The image-processing engine 250 comprises a processor element 251, SRAMs 252 and 253, a memory interface (I/F) 254, and a DMA controller (PE-DMAC) 255, which have respectively similar functions to the processor element 151, the SRAMs 152 and 153, the memory interface (I/F) 154, and the DMA controller (PE-DMAC) 155 in the data processing unit 150 illustrated in FIG. 3.

When the LSI has the above construction according to the second embodiment, it is possible to prevent the lowering of the efficiency in DMA transfer associated with two-dimensional access. In the LSI according to the second embodiment, a read-transfer request to cut out data in a rectangular area from the frame memory 13 is used in a similar manner to the first embodiment. The MEM-DMAC 232, which are arranged on the frame memory side for handling read-transfer requests, supports the two-dimensional access. In the two-dimensional access, the rectangular area is divided into a plurality of stripe areas, and a write transfer of data to the stripe areas is performed. In this case, the LSI is arranged to allow specifying the amount of data M which are read out from the frame memory 13 and are temporarily stored in the MEM-BUF 231a, and have a function of outputting to the CPU bus 201 a request for a write transfer when the amount of data stored in the MEM-BUF 231a reaches the specified amount of data M. Thus, a write-transfer operation is performed every time the amount of data stored in the MEM-BUF 231a reaches the specified amount of data M. For example, the specified amount of data M may be the maximum transferable data size based on the specification of the CPU bus 201. In this case, it is possible to reduce the number of write-transfer operations.

Hereinbelow, the function of storing, at consecutive addresses, data read out from a two-dimensional rectangular area in a frame memory is explained.

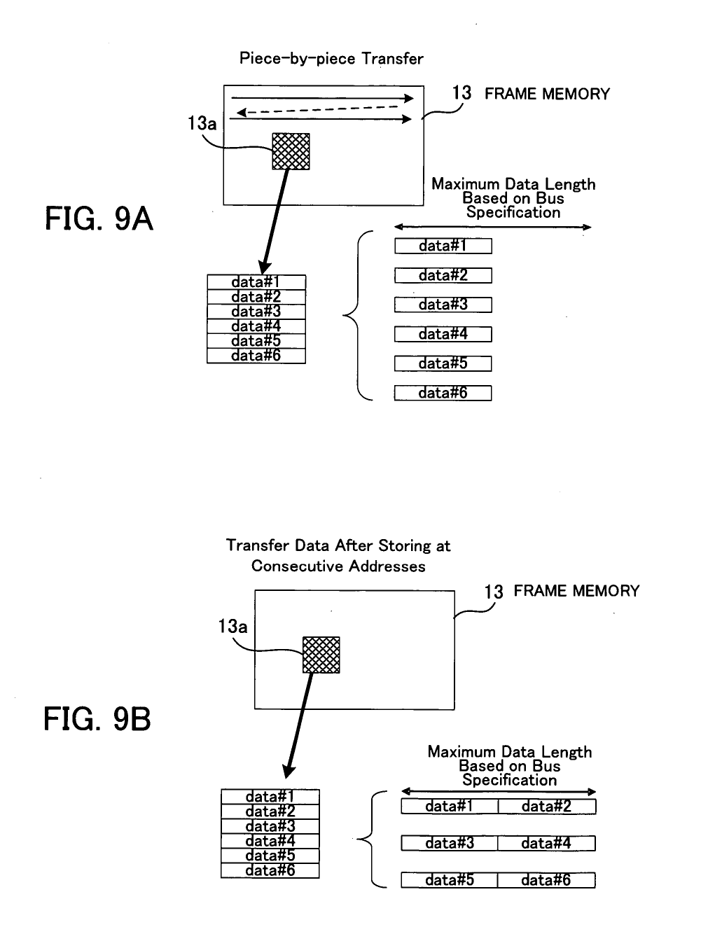

FIGS. 9A and 9B are diagrams illustrating examples of manners of transferring data divided into pieces each having a length equal to one-half the data width in the transfer. In the example of FIG. 9A, every time a piece of data is read out, the piece of data is transferred. On the other hand, in the example of FIG. 9B, transfer operations are performed after pieces of data are arranged at consecutive addresses. In both the examples of FIGS. 9A and 9B, the data width of the CPU bus 201 is twice the data length of each piece of data which is read out from the frame memory 13 by one reading operation.

Consider the case where image data 13a in the rectangular area are read out from the frame memory 13 as illustrated in FIGS. 9A and 9B. The storage area in the frame memory 13 is divided into a plurality of lines, and consecutive addresses are assigned from the left end to the right end of each line as indicated by the solid arrows in the frame memory 13 in FIG. 9A. The address assigned to the right end of each line continues to the left end of the next line as indicated by the dashed arrow in FIG. 9A. In such a case, the addresses indicating the areas in which the image data 13a to be transferred are stored are not necessarily consecutive. That is, addresses assigned to storage areas are consecutive only when the storage areas are arranged in the horizontal direction (in an identical line). Therefore, it is necessary to divide the image data 13a into pieces respectively corresponding to the lines before the image data 13a are read out from the frame memory 13, where the number of the lines corresponds to the height (in the vertical direction) of the rectangular area in which the image data 13a are stored. In the examples of FIGS. 9A and 9B, the image data 13a are divided into six pieces “data#1” to “data#6.”

In the above situation, if each piece of data is transferred through the CPU bus 201 when the piece of data is read out as indicated in FIG. 9A, the transfer operation is required to be performed six times for completing transfer of the image data 13a. On the other hand, according to the second embodiment, the pieces of data read out from the frame memory 13 are temporarily stored at consecutive addresses, and then the pieces of data stored at consecutive addresses are successively transferred through the CPU bus 201 in units corresponding to the maximum data length, as illustrated in FIG. 9B. Thus, it is possible to complete transfer of the image data 13a by performing the transfer operation three times. The transferred data are stored at consecutive addresses in one of the SRAMs in the image-processing engine 250.

That is, in the case where a transfer operation is performed every time a piece of data is read out, the transfer operation is required to be performed six times for completing transfer of the image data 13a. On the other hand, transfer of the image data 13a can be completed by performing the transfer operation three times according to the second embodiment.

Further, the bus width of the CPU bus 201 does not necessarily coincide with an integer multiple of the data length of each piece of data. Therefore, in the case where the bus width of the CPU bus 201 does not coincide with an integer multiple of the data length of each piece of data, if a transfer operation is performed every time a piece of data is read out, unnecessary bits are transferred in every transfer operation.

However, even in the case where the bus width of the CPU bus 201 does not coincide with an integer multiple of the data length of each piece of data, when the data is one-dimensionally arranged at consecutive addresses in the MEM-BUF 231a, and divided according to the limitation by the specification of the CPU bus 201, only effective bits are transferred in each transfer operation except the last transfer operation. Therefore, it is possible to reduce unnecessarily (uselessly) transferred bits.

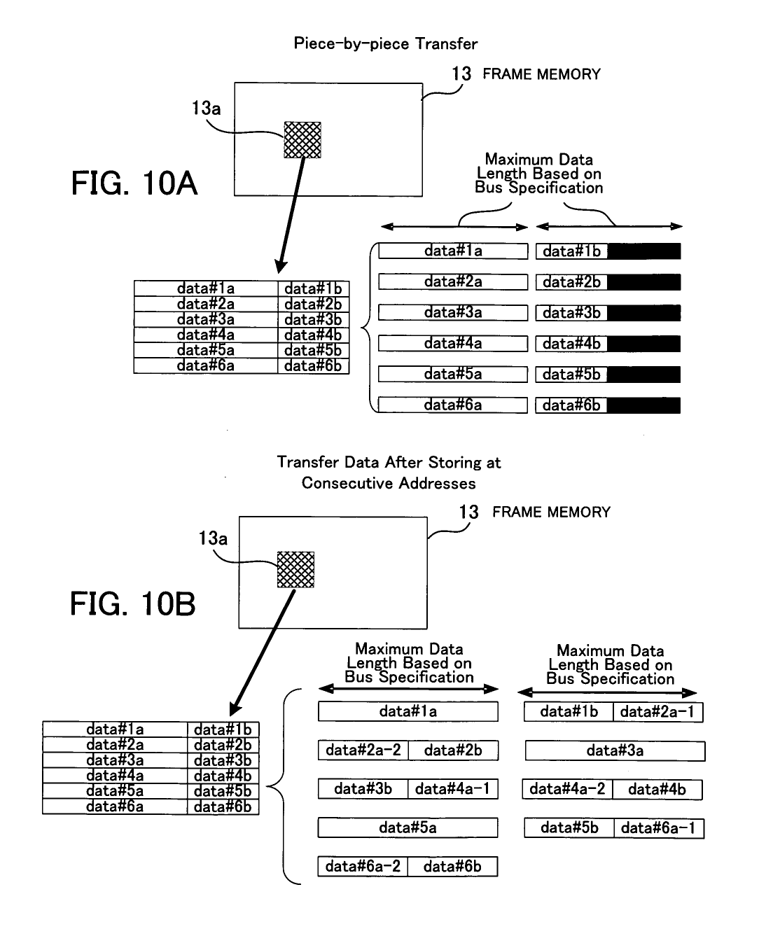

FIGS. 10A and 10B are diagrams illustrating examples of manners of transferring data which are divided into pieces each having a length equal to 1.5 times the data width in the transfer. In the example of FIG. 10A, every time a piece of data is read out, the piece of data is transferred through the CPU bus 201. On the other hand, in the example of FIG. 10B, transfer operations are performed after pieces of data are arranged at consecutive addresses. In both the examples of FIGS. 10A and 10B, the data width of the CPU bus 201 is ⅔ times the data length of each piece of data which is read out from the frame memory 13 by one reading operation.

In the example of FIG. 10A, the pair of pieces “data#1” and “data#1” out of the image data 13a is read from the frame memory 13 by one transfer operation. Similarly, each of the pair of pieces “data#2a” and “data#2b,” the pair of pieces “data#3a” and “data#3b,” the pair of pieces “data#4a” and “data#4b,” the pair of pieces “data#5a” and “data#b 5b,” and the pair of pieces “data#6a” and “data#6b” is read out from the frame memory 13 by one transfer operation.

In the above situation, if each pair of pieces of data is transferred through the CPU bus 201 when the pair of pieces of data is read out as indicated in FIG. 10A, the transfer operation is required to be performed twice for transferring each pair of pieces of data. Therefore, in order to complete transfer of the entire image data 13a, the transfer operation is required to be performed twelve times in total. In this case, transfer of unnecessary (useless) bits (which are, for example, all zero) can occur, as indicated by black bars in FIG. 10A.

On the other hand, according to the second embodiment, all the pieces of data read out from the frame memory 13 are temporarily stored at consecutive addresses, and then the data stored at consecutive addresses are successively transferred through the CPU bus 201 in units corresponding to the maximum data length, as illustrated in FIG. 10B. Specifically, in the example of FIG. 10B, the piece of data “data#1a” is transferred in the first transfer operation, the piece of data “data#1b” and the first half “data#2a-1” of the piece of data “data#2a” are transferred in the second transfer operation, and the second half “data#2a-2” of the piece of data “data#2a” and the piece of data “data#2b” are transferred in the third transfer operation. Thereafter, the following pieces of data are transferred in similar manners.

As explained above, in the case where each pair of pieces of data is transferred by two data transfer operations as in the example of FIG. 10A, unnecessary (useless) bits are transferred in the six transfer operations out of the twelve transfer operations. On the other hand, according to the second embodiment, the transfer of the entire image data 13a is completed by nine transfer operations since unnecessary (useless) bits are not transferred as illustrated in FIG. 10B. The transferred data are stored at consecutive addresses in one of the SRAMs in the image-processing engine 250.

In order to execute the processing as indicated in FIGS. 9A, 9B, 10A, and 10B, the MEM-DMAC 232 in the memory interface unit 230 comprises first and second sequencers. The first sequencer in the MEM-DMAC 232 performs processing for receiving a read-transfer request from the PE-DMAC 255 and processing for requesting the memory controller 231 to access the frame memory 13. The second sequencer in the MEM-DMAC 232 performs processing for requesting the CPU bus 201 to perform a write-transfer operation and processing for requesting the memory controller 231 to transfer data.

Similarly, the memory controller 231 in the memory interface unit 230 also comprises first and second sequencers. The first sequencer in the memory controller 231 performs processing for accessing the frame memory 13. The second sequencer in the memory controller 231 performs processing for transferring data through the CPU bus 201.

Hereinbelow, details of the processing performed by the first and second sequencers in each of the MEM-DMAC 232 and the memory controller 231 are explained below. In the following explanations, assignment and comparison of variables are indicated in accordance with the C notation.

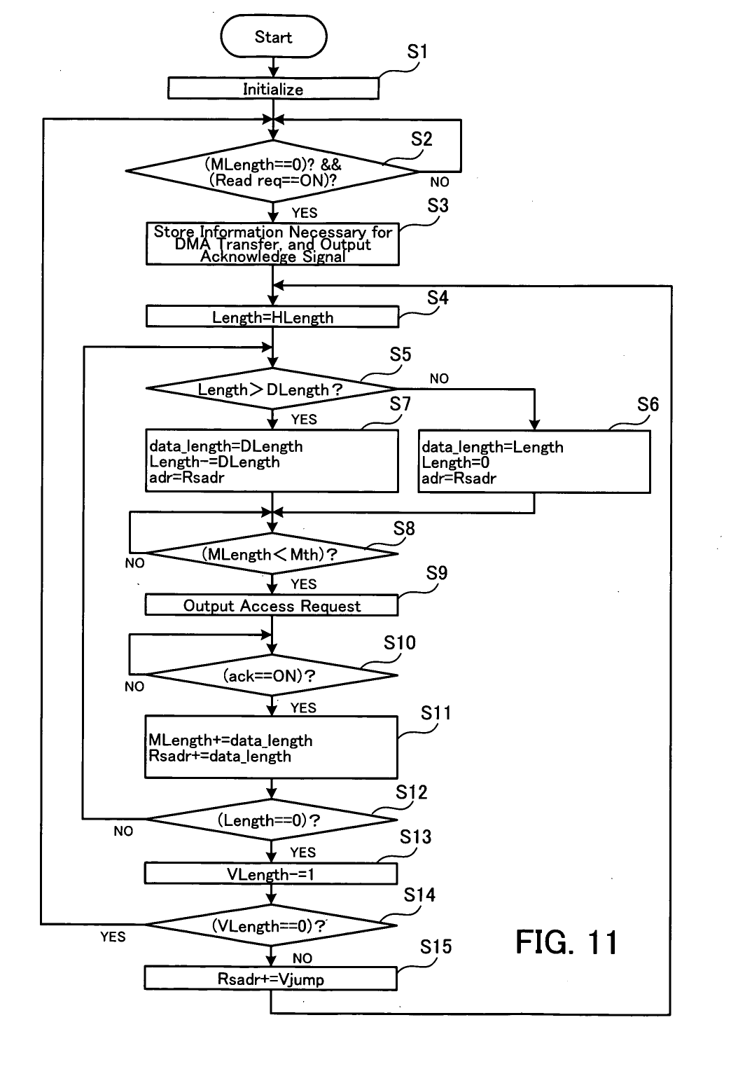

FIG. 11 is a flow diagram indicating processing performed by the first sequencer in the DMA controller (MEM-DMAC) 232. The processing illustrated in FIG. 11 is explained below step by step. In each of the following steps, when a write access to a variable “MLength” is performed, it is always necessary to check for a conflict with another access from the second sequencer in the MEM-DMAC 232.

<Step S1>When the system is started, the first sequencer in the MEM-DMAC 232 performs processing for initialization, so that the acknowledge signal “Read ack” is set in the OFF state, and the value “MLength” is to zero, where the acknowledge signal “Read ack” is outputted through the dedicated lines 20 to the PE-DMAC 255 in response to a read-transfer request, and the variable “MLength” indicates the length of data stored in the MEM-BUF 231a. This processing for initialization is performed only once when the system is powered on or reset. Therefore, after the power-on, the operation of the first sequencer in the MEM-DMAC 232 normally transits from step S2 to step S14.

<Step S2>The first sequencer in the MEM-DMAC 232 determines whether or not the condition that the variable “MLength” is zero and a signal “Read req” indicating the read-transfer request is ON is satisfied. In particular, the condition “MLength=0” is confirmed in order to prevent mixture of data corresponding to the immediately preceding request and data corresponding to the request the acceptability of which is to be determined. In addition, the signal “Read req” indicating the read-transfer request becomes ON when a read-transfer request “Read req” is sent from the PE-DMAC 255 in the image-processing engine 250 to the MEM-DMAC 232 in the memory interface unit 230 through the dedicated lines 20. When the above condition is satisfied, the operation goes to step S3. When the above condition is not satisfied, the processing in step S2 is repeated until the conditions is satisfied.

<Step S3> The first sequencer in the MEM-DMAC 232 stores information which is necessary for DMA transfer, and outputs an acknowledge signal “Read ack” to the PE-DMAC 255. The information necessary for DMA transfer is supplied from the PE-DMAC 255 through the dedicated lines 20, and includes the read-start address “Rsadr,” the horizontal data length “HLength,” the vertical data length “VLength,” the address displacement “Vjump” in the vertical direction, and the write-start address “Wsadr.” The address displacement “Vjump” in the vertical direction is the difference between the end address in each line of image data to be transferred and the leading address in the next line of the image data.

When the vertical data length “VLength” is two or more, the two-dimensional rectangular access is performed. In the case of one-dimensional access, the address displacement “Vjump” in the vertical direction is “Don't care.”

When the acknowledge signal is activated, the acknowledge signal “Read ack” on the dedicated lines 20 is changed from OFF to ON, and is then returned to OFF, so as to produce a single pulse. That is, a high level pulse signal is outputted on the dedicated lines 20.

<Step S4> The first sequencer in the MEM-DMAC 232 assigns the horizontal data length “HLength” to a variable “Length.”

<Step S5> The first sequencer in the MEM-DMAC 232 determines whether or not the variable “Length” is equal to or smaller than a value “DLength,” which indicates the maximum transfer size in the access to the frame memory 13. The value “DLength” is predetermined on the basis of the storage capacity of the MEM-BUF 231a, the data transfer efficiency in the system, and the like. When the variable “Length” is equal to or smaller than the value “DLength,” the operation goes to step S6. When the variable “Length” is greater than the value “DLength,” the operation goes to step S7.

<Step S6> first sequencer in the MEM-DMAC 232 assigns the variable “Length” to a variable “data length,” which indicates the data length. Then, the first sequencer in the MEM-DMAC 232 sets the variable “Length” to zero, and assigns the read-start address “Rsadr” to a variable “adr,” which indicates the start address. Thereafter, the operation goes to step S8.

<Step S7> first sequencer in the MEM-DMAC 232 assigns the variable “DLength” to the variable “data_length,” subtracts the value “DLength” from the value “Length,” and assigns the variable “Rsadr” to the variable “adr.” Thereafter, the operation goes to step S8.

<Step S8> first sequencer in the MEM-DMAC 232 determines whether or not the variable “MLength” is smaller than a threshold value “Mth,” which is predetermined on the basis of the size of the MEM-BUF 231a so as to avoid overflow from the MEM-BUF 231a.

When the variable “MLength” is smaller than the threshold value “Mth,” the operation goes to step S9. When the variable “MLength” is equal to or greater than the threshold value “Mth,” the processing in step S8 is repeated (i.e., the first sequencer in the MEM-DMAC 232 waits) until the variable “MLength” becomes smaller than the threshold value “Mth.” In parallel with the operation of the first sequencer in the MEM-DMAC 232, the second sequencer in the MEM-DMAC 232 performs processing in dependence on the value “MLength” and independence of the first sequencer in the MEM-DMAC 232, so that the value “MLength” is reduced by the operation of the second sequencer in the MEM-DMAC 232.

<Step S9> first sequencer in the MEM-DMAC 232 outputs to the first sequencer in the memory controller 231 an access request “req” for access to the frame memory 13, the start address “adr,” and the data length “data_length.” When the first sequencer in the memory controller 231 receives the access request, the first sequencer in the memory controller 231 performs processing for receiving the access request “req,” starts access to the frame memory 13, and stores all data which are read out from the frame memory 13, in the MEM-BUF 231a. Then, the first sequencer in the memory controller 231 issues an acknowledge signal “ack” to the first sequencer in the MEM-DMAC 232.

<Step S10> first sequencer in the MEM-DMAC 232 waits for the acknowledge signal “ack” from the first sequencer in the memory controller 231. When the first sequencer in the MEM-DMAC 232 receives the acknowledge signal, the operation goes to step S11. When the first sequencer in the MEM-DMAC 232 does not receive the acknowledge signal, the first sequencer in the MEM-DMAC 232 repeats the processing in step S10 until the first sequencer in the MEM-DMAC 232 receives the acknowledge signal.

<Step S11>When the first sequencer in the MEM-DMAC 232 receives the acknowledge signal “ack” from the first sequencer in the memory controller 231, the first sequencer in the MEM-DMAC 232 adds the value “data_length” to each of the value “MLength” and the value “Rsadr.”

<Step S12> first sequencer in the MEM-DMAC 232 determines whether or not the value “Length” is zero. When the value “Length” is zero, the operation goes to step S13. When the value “Length” is not zero, the operation goes to step S5.

<Step S13> first sequencer in the MEM-DMAC 232 subtracts one from the vertical data length “VLength.”

<Step S14> first sequencer in the MEM-DMAC 232 determines whether or not the vertical data length “Length” is zero. When the vertical data length “VLength” is not zero, the operation goes to step S15. When the vertical data length “VLength” is zero, the operation goes to step S2, and waits for the next read-transfer request.

<Step S15> first sequencer in the MEM-DMAC 232 adds the address displacement “Vjump” in the vertical direction to the read-start address “Rsadr.” Thereafter, the operation goes to step S4.

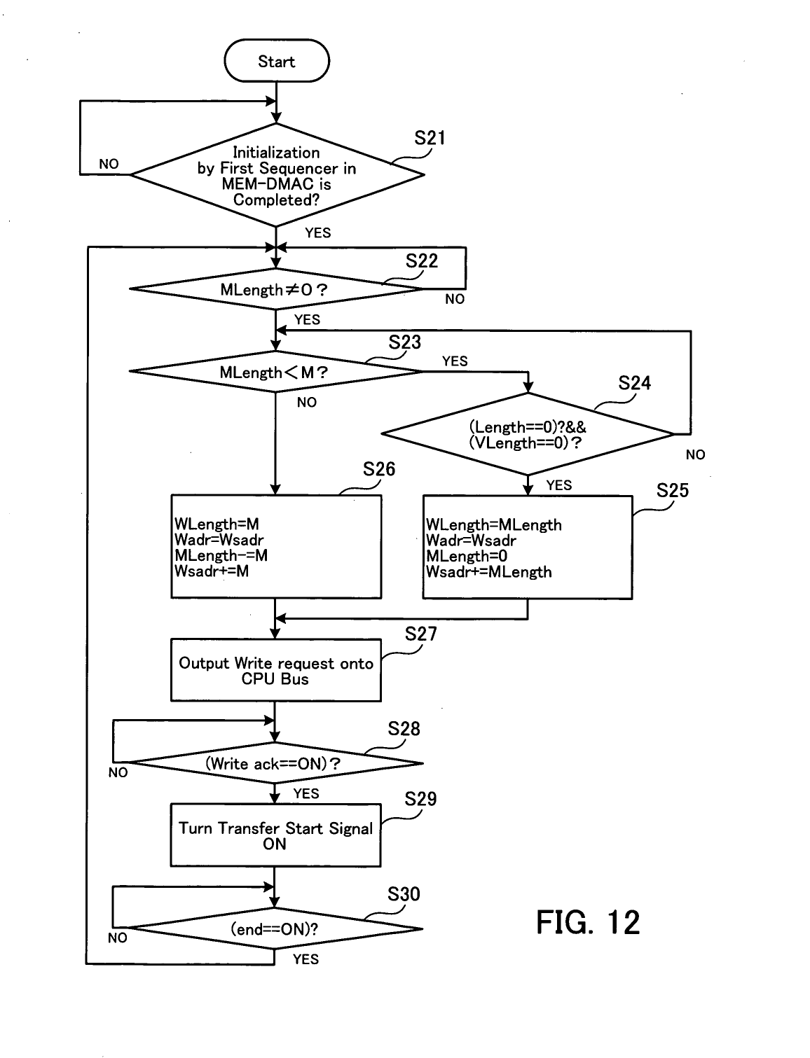

Next, the processing performed by the second sequencer in the MEM-DMAC 232 is explained below. FIG. 12 is a flow diagram indicating processing performed by the second sequencer in the DMA controller (MEM-DMAC) 232. The processing illustrated in FIG. 12 is explained below step by step. In each of the following steps, when a write access to the variable “MLength” is performed, it is always necessary to check for a conflict with another access from the first sequencer in the MEM-DMAC 232.

<Step S21> second sequencer in the MEM-DMAC 232 determines whether or not the processing for initialization performed by the first sequencer in the MEM-DMAC 232 is completed. When yes is determined, the operation goes to step S22. When no is determined, the second sequencer in the MEM-DMAC 232 repeats the processing in step S21, and waits for completion of the initialization by the first sequencer in the MEM-DMAC 232.

<Step S22> second sequencer in the MEM-DMAC 232 determines whether or not the value “MLength” is zero. When the value “MLength” is not zero, the operation goes to step S23. When the value “MLength” is zero, the second sequencer in the MEM-DMAC 232 repeats the processing in step S22, and waits for the value “MLength” to be updated. The value “MLength” is updated in the processing performed in step S11 by the first sequencer in the MEM-DMAC 232 when the first sequencer in the MEM-DMAC 232 performs processing for accessing the frame memory 13.

<Step S23> second sequencer in the MEM-DMAC 232 determines whether or not the value “MLength” is smaller than the maximum data length “M” according to the specification of the CPU bus 201. When yes is determined, the operation goes to step S24. When no is determined, the operation goes to step S26.

<Step S24> second sequencer in the MEM-DMAC 232 determines whether or not the condition that the value “Length” is zero and the vertical data length “VLength” is zero is satisfied. When the above condition is satisfied, the operation goes to step S25. When the above condition is not satisfied, the operation goes to step S23. In addition, the above condition indicates that the first sequencer in the MEM-DMAC 232 has performed the operation in step S13, and the state of the first sequencer in the MEM-DMAC 232 has made a transition to step S2.

<Step S25> second sequencer in the MEM-DMAC 232 sets the data size “WLength” in the write-transfer operation equal to the value “MLength,” a write address “Wadr” equal to the value “Wsadr,” and the value “MLength” equal to zero. Further, the second sequencer in the MEM-DMAC 232 adds the value “MLength” to the value “Wsadr.” Thereafter, the operation goes to step S27. The operation in step S25 is performed when the last portion of data is transferred by DMA. In step S25, the addition to the value “Wsadr” is indicated for clarifying the difference from the corresponding operation in step S26.

<Step S26> second sequencer in the MEM-DMAC 232 sets the data size “WLength” in the write-transfer operation equal to the value “M,” and a write address “Wadr” equal to the value “Wsadr.” In addition, the second sequencer in the MEM-DMAC 232 subtracts the value “M” from the value “MLength,” and adds the value “M” to the value “Wsadr.”

<Step S27> second sequencer in the MEM-DMAC 232 issues a write-transfer request “Write req” onto the CPU bus 201. In response to the write-transfer request, the bus controller 202 performs arbitration with regard to the use of the CPU bus 201.

<Step S28> second sequencer in the MEM-DMAC 232 determines whether or not the write acknowledge signal “Write ack” outputted from the bus controller 202 is “ON.” When yes is determined, the operation goes to step S29. When no is determined, the second sequencer in the MEM-DMAC 232 repeated the operation in step S28, and waits for the write acknowledge signal “Write ack” to become “ON.” When the bus controller 202 grants the memory interface unit 230 permission to exclusively use the CPU bus 201, the bus controller 202 sets the write acknowledge signal “Write ack” in the ON state.

<Step S29> second sequencer in the MEM-DMAC 232 outputs to the second sequencer in the memory controller 231 a start signal “start” for starting transfer to the CPU bus 201. Specifically, the second sequencer in the MEM-DMAC 232 sets the outputted start signal “start” in the ON state.

<Step S30> second sequencer in the MEM-DMAC 232 determines whether or not the end signal inputted from the second sequencer in the memory controller 231 is ON. When yes is determined, the operation goes to step S22. When no is determined, the second sequencer in the MEM-DMAC 232 repeats the processing in step S30, and waits for input of an active end signal. Specifically, the active end signal is a high level pulse signal.

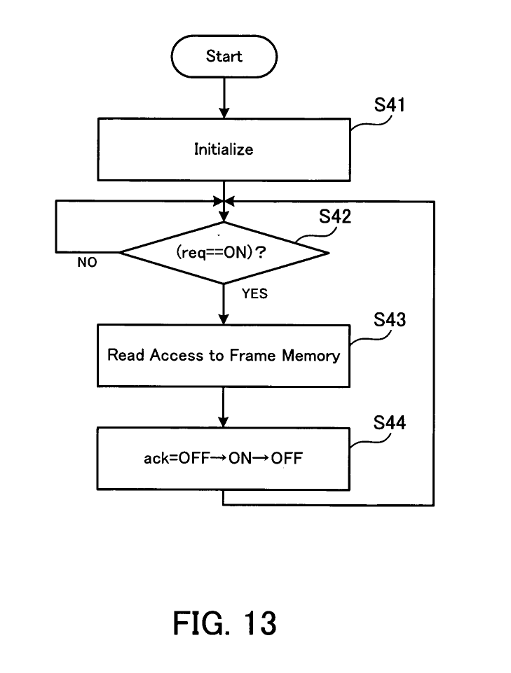

Next, the processing performed by the first sequencer in the memory controller 231 is explained below. FIG. 13 is a flow diagram indicating processing performed by the first sequencer in the memory controller 231. The processing illustrated in FIG. 13 is explained below step by step.

<Step S41> first sequencer in the memory controller 231 performs processing for initialization. In the processing for initialization, the first sequencer in the memory controller 231 sets the acknowledge signal “ack” in the OFF state.

<Step S42> first sequencer in the memory controller 231 determines whether or not an access-request signal (a signal indicating the aforementioned access request “req” to request access to the frame memory 13) is ON. When yes is determined, the operation goes to step S43. When no is determined, the first sequencer in the memory controller 231 repeats the processing in step S42, and waits for the access-request signal “req” to become ON.

<Step S43> first sequencer in the memory controller 231 performs a read access to the frame memory 13 in accordance with the start address “adr” and the data length “data_length” which are received from the MEM-DMAC 232. Then, the first sequencer in the memory controller 231 stores in the MEM-BUF 231a data which are read out from the frame memory 13.

<Step S44> first sequencer in the memory controller 231 outputs an acknowledge signal “ack.” Specifically, the first sequencer in the memory controller 231 changes the state of the acknowledge signal “ack” from OFF to ON, and then returns the state of the acknowledge signal “ack” to OFF, so as to produce a single pulse. Thereafter, the operation goes to step S42.

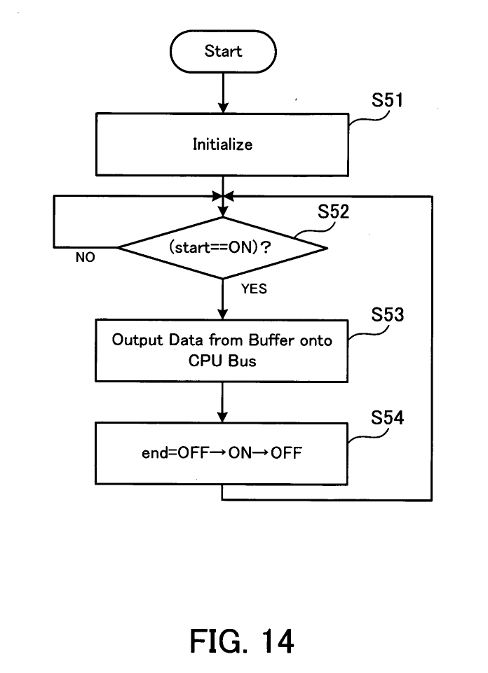

Next, the processing performed by the second sequencer in the memory controller 231 is explained below. FIG. 14 is a flow diagram indicating processing performed by the second sequencer in the memory controller 231. The processing illustrated in FIG. 14 is explained below step by step.

<Step S51> second sequencer in the memory controller 231 performs processing for initialization. In the processing for initialization, the second sequencer in the memory controller 231 sets the end signal “end” in the OFF state.

<Step S52> second sequencer in the memory controller 231 determines whether or not the start signal “start” (for starting data transfer through the CPU bus 201) is ON. When yes is determined, the operation goes to step S53. When no is determined, the second sequencer in the memory controller 231 repeats the processing in step S52, and waits for the start signal “start” to become ON.

<Step S53> second sequencer in the memory controller 231 reads out data from the MEM-BUF 231a in the order in which the data are stored in the MEM-BUF 231a, on the basis of the value “Wlength” (the data length in the write-transfer operation) received from the MEM-DMAC 232, and outputs the data onto the CPU bus 201 as the data “Out Mdata.”

<Step S54> second sequencer in the memory controller 231 outputs the end signal “end.” Specifically, the second sequencer in the memory controller 231 changes the state of the end signal “end” from OFF to ON, and then returns the state to OFF, so as to produce a single pulse. Thereafter, the operation goes to step S52.

When the MEM-DMAC 232 and the memory controller 231 perform the processing indicated in FIGS. 11 to 14, it is possible to efficiently perform the data transfer as illustrated in FIG. 9B (where transferred data are divided into pieces each having a length equal to one-half the data width in the transfer) and the data transfer as illustrated in FIG. 10B (where transferred data are divided into pieces each having a length equal to 1.5 times the data width in the transfer).

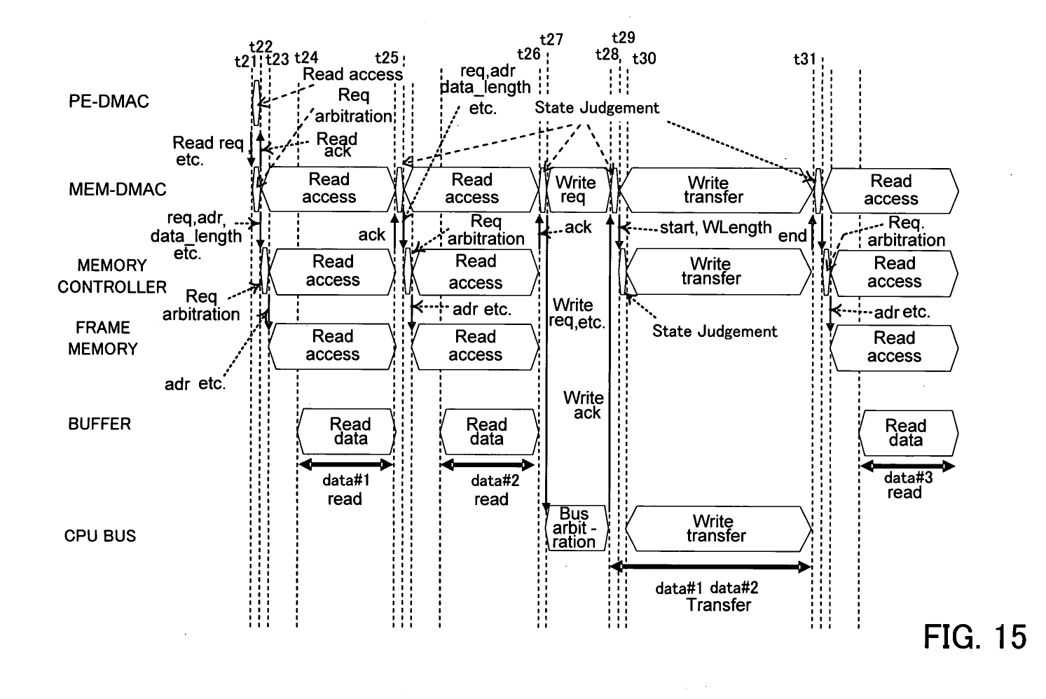

FIG. 15 is a timing diagram indicating timings of operations performed in the case where data divided into pieces are transferred, and each piece has a length equal to one-half the data width (M bytes) in the transfer. The timing diagram of FIG. 15 shows timings of operations in the data transfer as illustrated in FIG. 9B. That is, in this example, the read-transfer request requires access to a two-dimensional rectangular area, the horizontal data length “HLength” is one-half the maximum data width in the transfer based on the specification of the CPU bus 201, and the vertical data length “VLength” is six. In addition, it is assumed that the horizontal data length “HLength” is smaller than the maximum size “DLength” of data transferred in each operation of accessing the frame memory 13.

At time t21, a read-transfer request “Read req” outputted from the PE-DMAC 255 in the image-processing engine 250 is sent through the dedicated lines 20 to the first sequencer in the MEM-DMAC 232 in the memory interface unit 230. The first sequencer in the MEM-DMAC 232 recognizes that the value “MLength” (i.e., the variable indicating the length of data stored in the MEM-BUF 231a) is zero, and the signal indicating the read-transfer request “Read req” is ON. Then, the first sequencer in the MEM-DMAC 232 memorizes information necessary for DMA transfer, where the memorized information includes the read-start address “Rsadr,” the horizontal data length “HLength” (=M/2), the vertical data length “VLength” (=6), the address displacement “Vjump” in the vertical direction, and the write-start address “Wsadr.” Further, at time t22, the first sequencer in the MEM-DMAC 232 issues an acknowledge signal “Read ack” to the PE-DMAC 255.

When the horizontal data length “HLength” is assigned to the variable “Length,” the variable “Length” becomes equal to M/2, and does not exceed the maximum size “DLength” of data transferred in each operation of accessing, the frame memory 13. Therefore, the first sequencer in the MEM-DMAC 232 assigns the variable “Length” (=M/2) to the data length “data_length,” sets the variable “Length” to zero, and assigns the read-start address “Rsadr” to the start address “adr.” In addition, the first sequencer in the MEM-DMAC 232 confirms that the variable “MLength” is smaller than the value “Mth” (the threshold value predetermined for avoiding overflow from the MEM-BUF 231a). Then, at time t23, the first sequencer in the MEM-DMAC 232 outputs to the first sequencer in the memory controller 231 an access request “req” for access to the frame memory 13, the start address “adr,” and the data length “data_length.”

When the value “MLength” is greater than the value “Mth,” the first sequencer in the MEM-DMAC 232 waits for the “MLength” to become smaller than the value “Mth.” Since the second sequencer in the MEM-DMAC 232 performs processing in dependence on the value “MLength” and independence of the first sequencer in the MEM-DMAC 232, the value “MLength” is reduced by the operation of the second sequencer in the MEM-DMAC 232.

The first sequencer in the memory controller 231 performs processing for receiving the access request, starts access to the frame memory 13, and stores all data which are read out from the frame memory 13, in the MEM-BUF 231a. Since the frame memory 13 is realized by a DRAM, and it is necessary to wait for a predetermined time until the data are read out, the output of data from the frame memory 13 starts at time t24. The operation of the read access to the frame memory 13 is completed at time t25, and then the first sequencer in the memory controller 231 issues an acknowledge signal “ack” to the first sequencer in the MEM-DMAC 232.

When the first sequencer in the MEM-DMAC 232 receives the acknowledge signal, the first sequencer in the MEM-DMAC 232 adds the value “data_length” (=M/2) to each of the value “MLength” and the read-start address “Rsadr.” Then, the first sequencer in the MEM-DMAC 232 subtracts one from the vertical data length “VLength” after the first sequencer in the MEM-DMAC 232 confirms that the value “Length” is zero. Thus, the value “VLength” becomes five. Since the value “VLength” is still not zero, the first sequencer in the MEM-DMAC 232 continues the processing. Then, the first sequencer in the MEM-DMAC 232 adds the address displacement “Vjump” in the vertical direction to the value “Rsadr” for the next operation of read access to the frame memory 13.

The first sequencer in the MEM-DMAC 232 operates independently of the second sequencer in the MEM-DMAC 232, and performs read access to the frame memory 13 until both of the value “Length” and the value “VLength” become zero.

At time t26, the second sequencer in the MEM-DMAC 232 detects that the value “MLength” is not zero, and starts processing for outputting a write-transfer request “Write req” onto the CPU bus 201. First, the second sequencer in the MEM-DMAC 232 checks the value “MLength.” Since the value “MLength” is smaller than the value “M” (the maximum data width in the transfer according to the specification of the CPU bus 201), the second sequencer in the MEM-DMAC 232 determines whether or not the operation of the first sequencer in the MEM-DMAC 232 for accessing the frame memory 13 is completed, by checking whether or not both of the value “Length” and the value “VLength” become zero. When the second sequencer in the MEM-DMAC 232 determines that the operation of the first sequencer in the MEM-DMAC 232 for accessing the frame memory 13 is completed, the second sequencer in the MEM-DMAC 232 assigns the value “MLength” to the data size “WLength” in the write-transfer operation, sets the write address “Wadr” to the write-start address “Wsadr,” sets the value “MLength” to zero, and adds the value “MLength” to the write-start address “Wsadr.” Next, at time t27, the second sequencer in the MEM-DMAC 232 issues a write-transfer request “Write req,” and waits for the acknowledge signal “Write ack” outputted from the bus controller 202 corresponding to the CPU bus 201 to become ON.

At time t28, the MEM-DMAC 232 receives an active write acknowledge signal “Write ack” outputted from the bus controller 202. Since the active write acknowledge signal indicates that the memory interface unit 230 has acquired a right of use of the CPU bus 201, at time t29, the second sequencer in the MEM-DMAC 232 outputs an active start signal (transfer start signal) to the second sequencer in the memory controller 231. That is, the second sequencer in the MEM-DMAC 232 sets the start signal in the ON state. When the second sequencer in the memory controller 231 detects the ON state of the start signal, the second sequencer in the memory controller 231 reads out data from the MEM-BUF 231a in the order in which the data are stored in the MEM-BUF 231a, and outputs the data onto the CPU bus 201 as the data “Out Mdata” at time t30. Thereafter, at time t31, the second sequencer in the memory controller 231 outputs the end signal “end.” When the second sequencer in the MEM-DMAC 232 detects the ON state of the end signal “end,” the transfer operation is completed.

By the processing performed in the timespan from t21 to t31, the pieces of data “data#1” and “data#2” are sent to the image-processing engine 250 through the CPU bus 201 by a single DMA transfer operation Thereafter, similar processing is repeated, so that transfer of all the data in the rectangular area is completed.

As indicated in FIG. 15, the transfer latency from the timing of the read-transfer request “Read req” is great. However, the CPU bus is occupied only in the data transfer cycle.

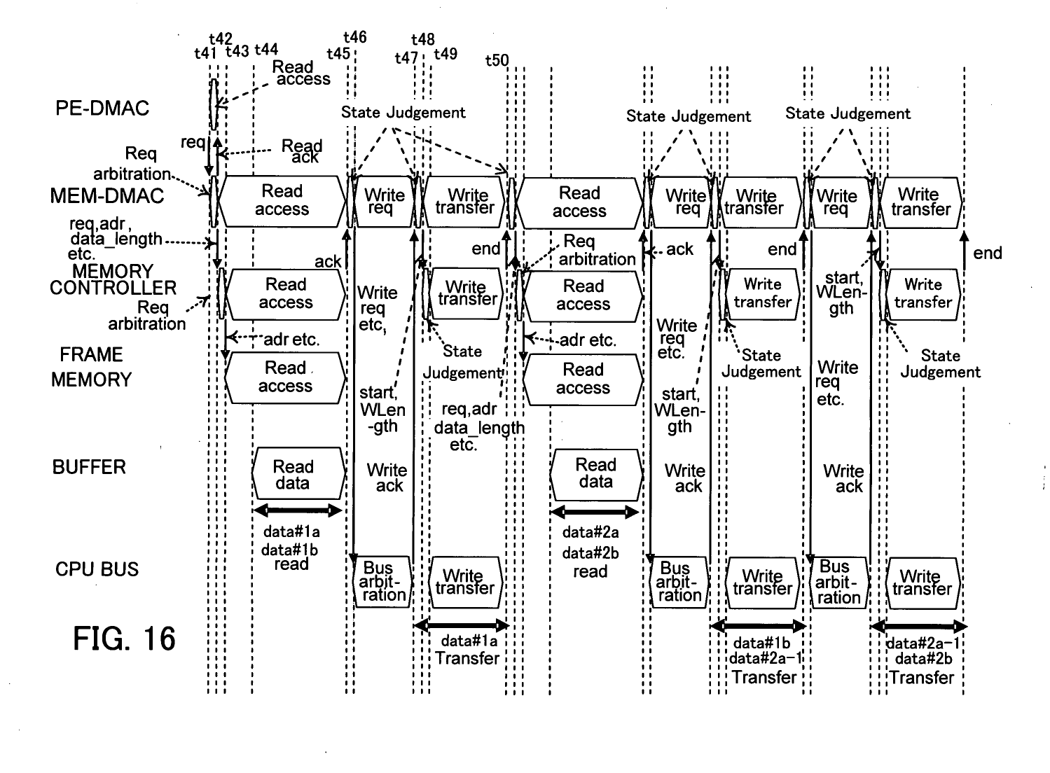

FIG. 16 is a timing diagram indicating timings of operations performed in the case where data divided into pieces are transferred, and each piece has a length equal to 1.5 times the data width in the transfer. The timing diagram of FIG. 16 shows timings of operations in the data transfer as illustrated in FIG. 10B. That is, in this example, the read-transfer request requires access to a two-dimensional rectangular area, the horizontal data length “HLength” is 3/2 times the maximum data width (M bytes) in the transfer according to the specification of the CPU bus 201, and the vertical data length “VLength” is six. In addition, it is assumed that the horizontal data length “HLength” is smaller than the maximum size “DLength” of data transferred in each operation of accessing the frame memory 13.

At time t41, a read-transfer request “Read req” outputted from the PE-DMAC 255 in the image-processing engine 250 is sent through the dedicated lines 20 to the first sequencer in the MEM-DMAC 232 in the memory interface unit 230. The first sequencer in the MEM-DMAC 232 recognizes that the value “MLength” (i.e., the variable indicating the length of data stored in the MEM-BUF 231a) is zero, and the signal indicating the read-transfer request “Read req” is ON. Then, the first sequencer in the MEM-DMAC 232 memorizes information necessary for DMA transfer, where the memorized information includes the read-start address “Rsadr,” the horizontal data length “HLength” (=3M/2), the vertical data length “VLength” (=6), the address displacement “Vjump” in the vertical direction, and the write-start address “Wsadr.” Further, at time t42, the first sequencer in the MEM-DMAC 232 issues an acknowledge signal “Read ack” to the PE-DMAC 255.

When the horizontal data length. “HLength” is assigned to the variable “Length,” the variable “Length” becomes equal to 3M/2, and does not exceed the maximum size “DLength” of data transferred in each operation of accessing the frame memory 13. Therefore, the first sequencer in the MEM-DMAC 232 assigns the variable “Length” (=3M/2) to the data length “data_length,” sets the variable “Length” to zero, and assigns the read-start address “Rsadr” to the start address “adr.” In addition, the first sequencer in the MEM-DMAC 232 confirms that the variable “MLength” is smaller than the value “Mth” (the threshold value predetermined for avoiding overflow from the MEM-BUF 231a). Then, at time t43, the first sequencer in the MEM-DMAC 232 outputs to the first sequencer in the memory controller 231 an access request “req” for access to the frame memory 13, the start address “adr,” and the data length “data_Length.”

When the value “MLength” is greater than the value “Mth,” the first sequencer in the MEM-DMAC 232 waits for the “MLength” to become smaller than the value “Mth.” Since the second sequencer in the MEM-DMAC 232 performs processing in dependence on the value “MLength” and independence of the first sequencer in the MEM-DMAC 232, the value “MLength” is reduced by the operation of the second sequencer in the MEM-DMAC 232.

The first sequencer in the memory controller 231 performs processing for receiving the access request, starts access to the frame memory 13, and stores all data which are read out (the pieces of data “data#1a” and “data#1”) in the MEM-BUF 231a. The output of data from the frame memory 13 starts at time t44. The operation of the read access to the frame memory 13 is completed at time t45, and then the first sequencer in the memory controller 231 issues an acknowledge signal “ack” to the first sequencer in the MEM-DMAC 232.

When the first sequencer in the MEM-DMAC 232 receives the acknowledge signal “ack,” the first sequencer in the MEM-DMAC 232 adds the value “data_length” (=3M/2) to each of the value “MLength” and the read-start address “Rsadr.” Then, the first sequencer in the MEM-DMAC 232 subtracts one from the vertical data length “VLength” after the first sequencer in the MEM-DMAC 232 confirms that the value “Length” is zero. Thus, the value “VLength” becomes five. Since the value “VLength” is still not zero, the MEM-DMAC 232 continues the processing. Then, the first sequencer in the MEM-DMAC 232 adds the address displacement “Vjump” in the vertical direction to the value “Rsadr” for another read access to the frame memory 13.

The first sequencer in the MEM-DMAC 232 operates independently of the second sequencer in the MEM-DMAC 232, and performs read access to the frame memory 13 until both of the value “Length” and the value “VLength” become zero.

At time t46, the second sequencer in the MEM-DMAC 232 detects that the value “MLength” is not zero, and starts processing for outputting a write-transfer request “Write req” onto the CPU bus 201. First, the second sequencer in the MEM-DMAC 232 checks the value “MLength.” The value “MLength” is initially 3M/2, and greater than the value “M” (the maximum data width in the transfer according to the specification of the CPU bus 201). That is, the condition for issuing a write-transfer request “Write req” for transfer of data (“data#1a”) with the data length “M” is satisfied. Therefore, the second sequencer in the MEM-DMAC 232 sets the value “WLength” (the data size in the write-transfer operation) equal to M, sets the write address “Wadr” equal to the write-start address “Wsadr,” subtracts M from the value “MLength,” and adds M to the write-start address “Wsadr.” Then, the second sequencer in the MEM-DMAC 232 issues a write-transfer request “Write req,” and waits for the write acknowledge signal “Write ack” outputted from the CPU bus 201 to become ON.

At time t47, the MEM-DMAC 232 receives an active write acknowledge signal “Write ack” outputted from the bus controller 202. Since the active write acknowledge signal indicates that the memory interface unit 230 has acquired a right of use of the CPU bus 201, at time t48, the second sequencer in the MEM-DMAC 232 sets the start signal (transfer start signal) outputted to the memory controller 231, in the ON state. When the second sequencer in the memory controller 231 detects the ON state of the start signal, the second sequencer in the memory controller 231 reads out data from the MEM-BUF 231a in the order in which the data are stored in the MEM-BUF 231a, where the length of the data read out from the MEM-BUF 231a at this time is equal to the value “WLength.” At time t49, the second sequencer in the memory controller 231 outputs the data read out from the MEM-BUF 231a, onto the CPU bus 201 as the data “Out Mdata.” Thereafter, at time t50, the second sequencer in the memory controller 231 outputs the end signal “end.” When the second sequencer in the MEM-DMAC 232 detects the ON state of the end signal “end,” the transfer operation is completed.

When the first sequencer in the MEM-DMAC 232 reads out the pieces of data “data#2a” and “data#2b” from the frame memory 13, the value “MLength” becomes 2M, and the second sequencer in the MEM-DMAC 232 performs transfer of the pieces of data “data# 1b” and “data#2a-1” with the data length of M. Thus, the value “MLength” becomes M. Then, the second sequencer in the MEM-DMAC 232 performs transfer of the pieces of data “data# 2a-2” and “data#2b” with the data length of M. Thereafter, the remaining pieces of data “data#3a,” “data#3b,” . . . , “data#6a,” and “data#6b” are transferred in similar manners.

If the above pieces of data are transferred in the manner of the first embodiment, because of the limitation by the maximum data width “M” in the transfer according to the specification of the CPU bus 201, each of the pieces of data “data#1a” to “data#6a” is transferred with the data size of M, and each of the pieces of data “data#1b” to “data#6b” is transferred with the data size of M/2. That is, in total twelve transfer operations are necessary. On the other hand, according to the second embodiment, the pieces of data “data#1a” to “data#6a” and “data#1b” to “data#6b” can be transferred by nine transfer operations as illustrated in FIG. 10B.

If the image data 13a are transferred in the manner of the first embodiment, it is necessary to access the frame memory 13 twelve times. On the other hand, when the image data 13a are transferred in the above-described manner of the second embodiment, the transfer of the image data 13a can be completed by accessing the frame memory 13 six times. That is, the number of memory access operations is reduced, and the burst length in each memory access operation can be increased. Therefore, in the case where the frame memory 13 is realized by a DRAM, it is possible to increase the data access efficiency in the DRAM. Further, in order to prevent overflow from the MEM-BUF 231a, it is necessary to limit the data length in each operation of accessing the DRAM. Thus, the capacity of the MEM-BUF 231a must be determined in consideration of the data access efficiency in the DRAM.

According to the second embodiment, the transfer efficiency can also be increased in transfer of other types of data. For example, consider a transfer of data obtained by accessing a two-dimensional rectangular area, where the read-transfer request requires access to the two-dimensional rectangular area, the horizontal data length “HLength” is 5/4 times the maximum data width (M bytes) in the transfer according to the specification of the CPU bus 201, and the vertical data length “VLength” is four.

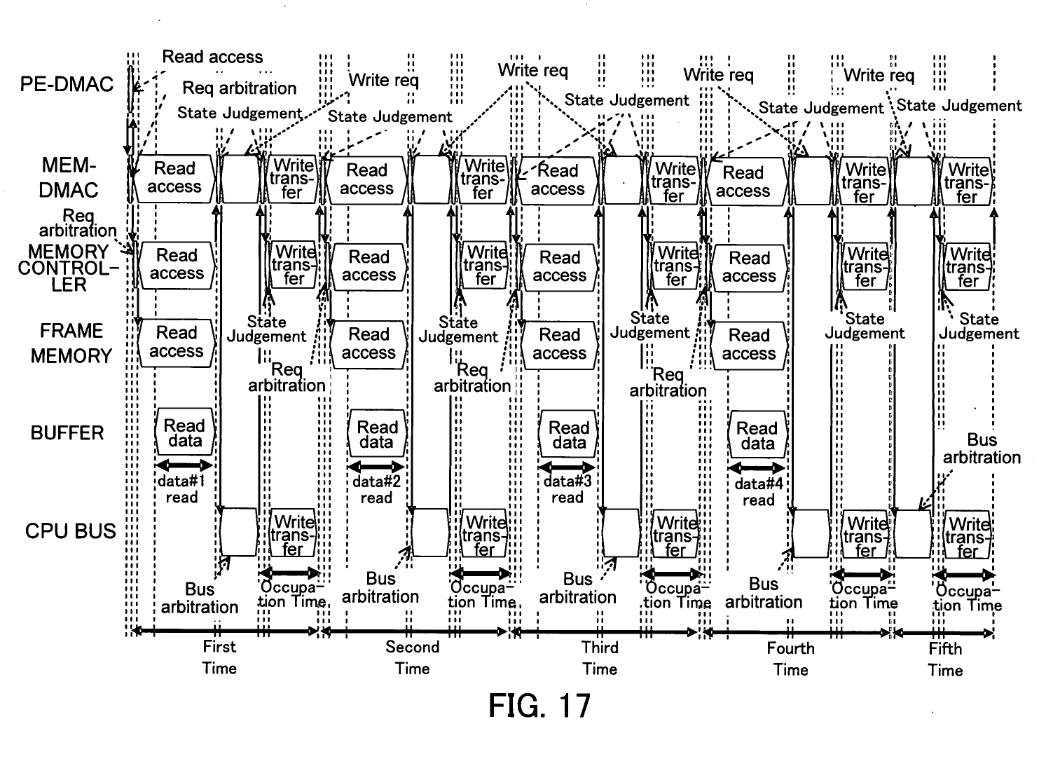

FIG. 17 is a timing diagram indicating timings of operations performed in the case where data divided into pieces are transferred, and each piece has a length equal to 5/4 times the data width in the transfer. In the example of FIG. 17, the rectangular area is divided into four stripe areas respectively having pieces of data “data#1” to “data#4.” As indicated in FIG. 17, the operation of reading data from the frame memory 13 is performed four times, and the operation of transferring data through the CPU bus 201 is performed five times.

As is evident from FIGS. 13 and 14, the first and second sequencers in the memory controller 231 operate completely independently of each other except for the access to the MEM-BUF 231a. Therefore, in the case where the MEM-BUF 231a is realized by a dual-port memory or a double-buffering structure, the operation of accessing the frame memory 13 and the DMA write operation can be realized by pipeline processing. In the case where the MEM-BUF 231a is realized by a double-buffering structure constituted by two memories, data are written in the MEM-BUF 231a by dividing the data into pieces each having a length corresponding to the maximum data width in the transfer according to the specification of the CPU bus 201, and alternately writing the pieces in the two memories.

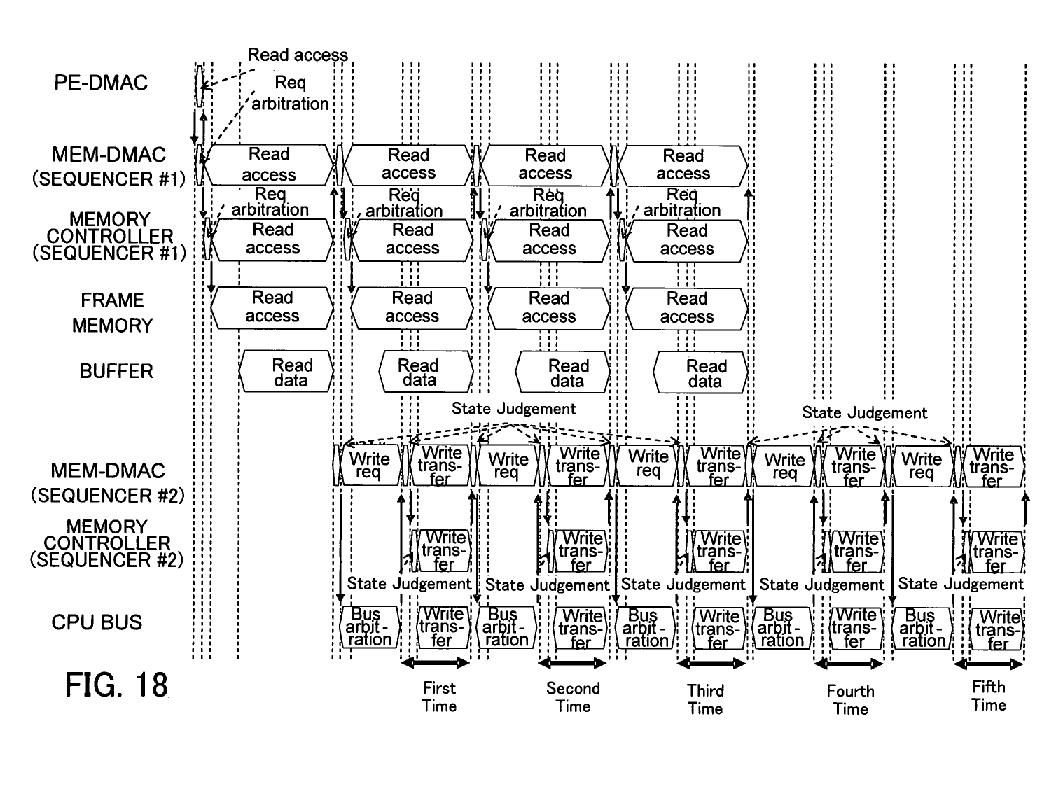

FIG. 18 is a timing diagram of the above pipeline processing. In FIG. 18, the first sequencer in the MEM-DMAC 232 is denoted by “MEM-DMAC (SEQUENCER #1),” the second sequencer in the MEM-DMAC 232 is denoted by “MEM-DMAC (SEQUENCER #2),” the first sequencer in the memory controller 231 is denoted by “MEMORY CONTROLLER (SEQUENCER #1) ,” and the second sequencer in the memory controller 231 is denoted by “MEMORY CONTROLLER (SEQUENCER #2).” When the operation of accessing the frame memory 13 and the DMA write operation can be realized by pipeline processing, it is possible to reduce the time necessary for the data transfer. In addition, the processing of the request from the PE-DMAC 255, together with the above operations, can also be performed by the pipeline processing.

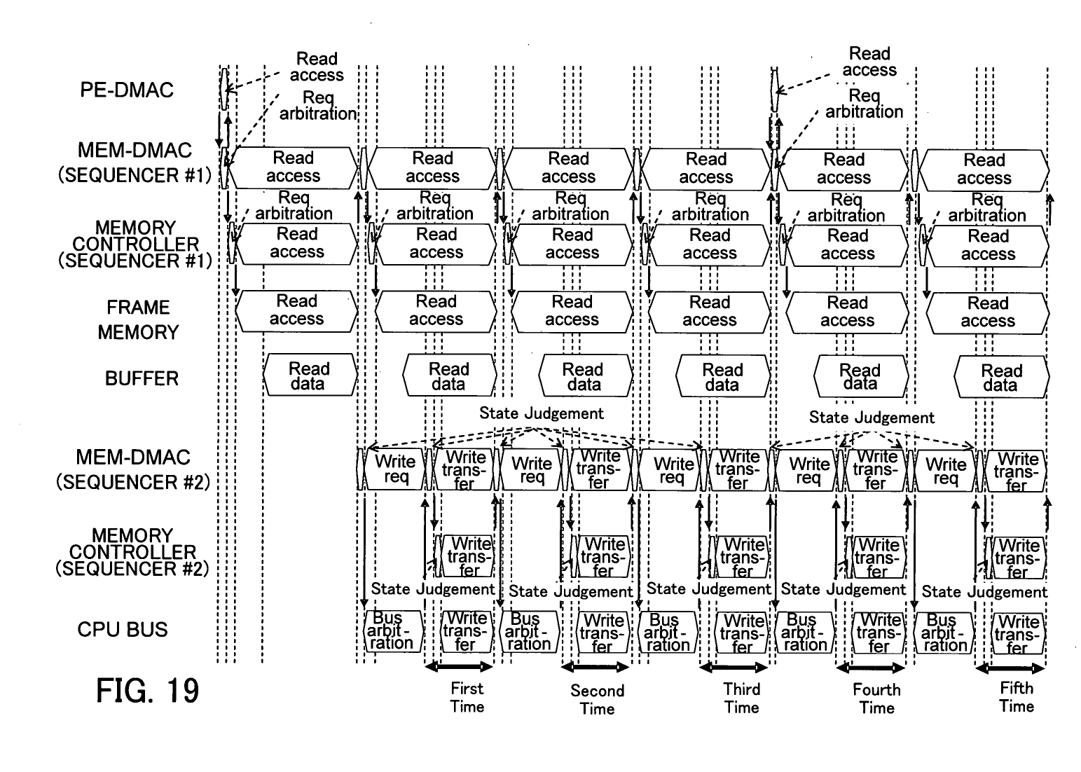

FIG. 19 is a timing diagram indicating timings of pipeline processing of a request from the DMA controller (PE-DMAC). In the example of FIG. 19, before a DMA write operation in response to a preceding read-transfer request from the PE-DMAC 255 is completed, the next read-transfer request is accepted, and an operation of read access to the frame memory 13 is performed.

The operations performed by the MEM-DMAC 232 in the example of FIG. 19 is different from the operations in FIG. 11. Hereinbelow, the differences from the operations in FIG. 11 are explained.

In the processing performed by the first sequencer in the MEM-DMAC 232, the operations performed for checking the read-transfer request “Read req” include the operation of checking whether or not the value “MLength” is equal to zero (in step S2 in FIG. 11). Therefore, it is impossible to return an acknowledge signal “Read ack” in response to the next read-transfer request from the PE-DMAC 255 until the transferring operation performed by the second sequencer in the MEM-DMAC 232 is completed. The operation of checking whether or not the value “MLength” is equal to zero is performed for preventing mixture, in the MEM-BUF 231a, of data corresponding to a request and data corresponding to the next request. Therefore, in the case where the request from the PE-DMAC 255 is pipeline processed as illustrated in FIG. 19, processing for preventing mixture of data corresponding to different requests, other than the above checking of the value “MLength” , is added to the operations for checking the read-transfer request “Read req.” For example, in order to identify the boundary between adjacent sets of data corresponding to different read-transfer requests, it is possible to add a pointer which indicates the end of each set of data corresponding to a read-transfer request. In this case, the second sequencer in the MEM-DMAC 232 can detect the position of the pointer, the operation of checking the “MLength” can be dispensed with, and the processing of the request from the PE-DMAC 255 can be realized by pipeline processing together with the other operations.

When the MEM-BUF 231a has a duplexed structure (for example, constituted by first and second buffers), the variable “MLength” is also doubled. For example, two variables “MLength#1” and “MLength#2” are used. In this case, the first buffer and the first variable “MLength#1” are used in processing of a first request, and the second buffer and the second variable “MLength#2” are used in processing of a second request. Thereafter, the first and second buffers are alternately used. Thus, processing of the request from the PE-DMAC 255 can be realized by pipeline processing together with the other operations.

According to the present invention, when a read request occurs in the data processing unit, the data processing unit outputs a DMA-transfer request to the data management unit through a dedicated line so that the data management unit can perform a write transfer by DMA. Therefore, it is possible to acquire a right of use of the bus after the data management unit becomes ready to transfer data, and increase the efficiency in the data transfer through the bus.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A data processing apparatus comprising:
a data processing unit which includes,
a processor,
a receiver-side DMA controller, and
a data storage area;
a data management unit which manages data, and includes,
a memory which stores the data,
a memory controller,
a transmitter-side DMA controller, and
a buffer;
a bus which connects the data processing unit and the data management unit for use in DMA transfer between the data processing unit and the data management unit; and
a dedicated line which connects the data processing unit and the data management unit for use in transmission of a first request for DMA transfer;
wherein the whole or a part of the data is designated in the first request, and the receiver-side DMA controller outputs the first request through the dedicated line when the processor outputs a second request to read the whole or the part of the data,
the transmitter-side DMA controller receives through the dedicated line the first request outputted from the receiver-side DMA controller, outputs a third request to read from the memory the whole or the part of the data designated by the first request, and acquires a right of use of the bus and outputs a fourth request to transfer the whole or the part of the data through the bus by DMA and write the whole or the part of the data in the data storage area when the whole or the part of the data is stored in the buffer, and
the memory controller reads out the whole or the part of the data from the memory and stores the whole or the part of the data in the buffer when the third request is outputted from the receiver-side DMA controller, and transfers the whole or the part of the data from the buffer through the bus by DMA so as to write the whole or the part of the data in the data storage area in the data processing unit when the transmitter-side DMA controller outputs the fourth request.

2. The data processing apparatus according to claim 1, wherein when the whole or the part of the data designated in the first request are stored at discrete addresses in the memory, the memory controller stores the whole or the part of the data read out from the memory, in consecutive storage areas in the buffer, and divides the whole or the part of the data stored in the buffer, into data pieces each having such a length that the data pieces can be transferred through the bus by DMA.

3. The data processing apparatus according to claim 1, wherein the memory controller receives the third request, and the third request designates data representing a rectangular area of an image as the whole or the part of the data stored in the memory, the memory controller divides the rectangular area into a plurality of pieces each of which has a rectangular shape and in each of which addresses are consecutive, reads out image data corresponding to the rectangular area on a piece-by-piece basis, stores the image data in consecutive storage areas in the buffer, and divides the image data stored in the buffer, into data pieces each having such a length that the data pieces can be transferred through the bus by DMA.

4. The data processing apparatus according to claim 1, wherein the transmitter-side DMA controller includes,
a read controller which receives through the dedicated line the first request outputted from the receiver-side DMA controller, and outputs the third request, and
a write-transfer controller which acquires the right of use of the bus, and outputs the fourth request, when the whole or the part of the data is stored in the buffer,
wherein the read controller and the write-transfer controller operate independently of each other.

5. The data processing apparatus according to claim 4, wherein the third request outputted from the read controller and the fourth request outputted from the write-transfer controller are pipeline processed by the transmitter-side DMA controller.

6. The data processing apparatus according to claim 1, wherein the memory controller includes,
a data read circuit which reads out the whole or the part of the data from the memory, and stores the whole or the part of the data in the buffer, when the third request is outputted from the receiver-side DMA controller, and
a DMA transfer circuit which transfers the whole or the part of the data stored in the buffer, through the bus by DMA, and writes the whole or the part of the data in the data storage area in the data processing unit, when the transmitter-side DMA controller outputs the fourth request,
wherein the data read circuit and the DMA transfer circuit operate independently of each other.

7. The data processing apparatus according to claim 6, wherein the memory controller performs, by pipeline processing, an operation of the data read circuit storing the whole or the part of the data in the buffer and an operation of the DMA transfer circuit transferring the whole or the part of the data from the buffer through the bus by DMA and writing the whole or the part of the data in the data storage area in the data processing unit.

8. A method for performing DMA transfer between a data processing unit including a processor and a data management unit managing a memory, comprising the steps of:
(a) outputting a first request for DMA transfer designating the whole or a part of data managed by the data management unit, from the data processing unit to the data management unit through a dedicated line which connects the data processing unit with the data management unit, when the processor outputs a second request to read the whole or the part of the data;
(b) reading out from the memory the whole or the part of the data designated in the first request, and storing the whole or the part of the data in a buffer in the data management unit, in response to the first request;
(c) acquiring a right of use of the bus when the whole or the part of the data is stored in the buffer; and
(d) transferring the whole or the part of the data from the buffer through the bus by DMA, and writing the whole or the part of the data in a data storage area in the data processing unit.
